(19) United States
(12) Patent Application Publication
(10) Pub. No.: US 2024/0292003 A1
(43) Pub. Date: Aug. 29, 2024

(54) APPLYING AN OVERLAY PROCESS TO A PICTURE

(71) Applicant: Telefonaktiebolaget LM Ericsson (publ), Stockholm (SE)

(72) Inventors: Mitra DAMGHANIAN, Upplands-Bro (SE); Martin PETTERSSON, Vallentuna (SE); Rickard SJÖBERG, Stockholm (SE)

(73) Assignee: Telefonaktiebolaget LM Ericsson (publ), Stockholm (SE)

(21) Appl. No.: 18/572,999

(22) PCT Filed: Jun. 20, 2022
(86) PCT No.: PCT/EP2022/066740

§ 371 Date: Dec. 21, 2023

Related U.S. Application Data
(60) Provisional application No. 63/216,279, filed on Jun. 29, 2021.

(51) Int. Cl. H04N 19/172; H04N 19/167; H04N 19/169; H04N 19/70; H04N 19/85

(52) U.S. Cl. CPC H04N 19/172; H04N 19/167; H04N 19/188; H04N 19/70; H04N 19/85

(57) ABSTRACT

A method for applying an overlay process to a picture in a bitstream. In one embodiment the method includes decoding a first set of one or more overlay process parameters from syntax elements in the bitstream, the first set of one or more overlay process parameters specifying a first overlay process. The method also includes decoding a first set of one or more picture partitioning parameters from syntax elements in the bitstream, the first set of one or more picture partitioning parameters specifying a first segment area of the picture, wherein a boundary of the first segment area of the picture is not fully aligned with a boundary of the picture or a boundary of any subpictures of the picture or a boundary of any slices in the picture. The method further includes decoding the picture, wherein decoding the picture comprises applying the first overlay process on the first segment area of the picture using the first set of one or more overlay process parameters.

### TECHNICAL FIELD

Disclosed are embodiments related to applying an overlay process to a picture.

### BACKGROUND

### 1. HEVC and VVC

High Efficiency Video Coding (HEVC) is a block-based video codec standardized by ITU-T and MPEG that utilizes both temporal and spatial prediction. Spatial prediction is achieved using intra (I) prediction from within the current picture. Temporal prediction is achieved using uni-directional (P) or bi-directional inter (B) prediction on block level from previously decoded reference pictures. In the encoder, the difference between the original pixel data and the predicted pixel data, referred to as the residual, is transformed into the frequency domain, quantized and then entropy coded before transmitted together with necessary prediction parameters such as prediction mode and motion vectors, also entropy coded. The decoder performs entropy decoding, inverse quantization and inverse transformation to obtain the residual, and then adds the residual to an intra or inter prediction to reconstruct a picture.

MPEG and ITU-T are working on the successor to HEVC within the Joint Video Exploratory Team (JVET). The name of this video codec is Versatile Video Coding (VVC) and version 1 of VVC specification, which is the current version of VVC at the time of writing, has been published as Rec. ITU-T H.2661 ISO/IEC 23090-3, “Versatile Video Coding”, 2020.

### 2. Components

A video (a.k.a., video sequence) consists of a series of pictures (a.k.a., images) where each picture consists of one or more components. Each component can be described as a two-dimensional rectangular array of sample values. It is common that a picture in a video sequence consists of three components; one luma component Y where the sample values are luma values and two chroma components Cb and Cr, where the sample values are chroma values. It is also common that the dimensions of the chroma components are smaller than the luma components by a factor of two in each dimension. For example, the size of the luma component of an HD picture would be 1920×1080 and the chroma components would each have the dimension of 960×540. Components are sometimes referred to as color components.

### 3. Blocks and Units

A block is one two-dimensional array of samples. In video coding, each component is split into blocks and the coded video bitstream consists of a series of coded blocks. It is common in video coding that the picture is split into units that cover a specific area of the picture. Each unit consists of all blocks from all components that make up that specific area and each block belongs fully to one unit. The macroblock in H.264 and the Coding unit (CU) in HEVC are examples of units.

A block can alternatively be defined as a two-dimensional array that a transform used in coding is applied to. These blocks are known under the name “transform blocks.” Alternatively, a block can be defined as a two-dimensional array that a single prediction mode is applied to. These blocks can be called “prediction blocks”. In this application, the word block is not tied to one of these definitions but that the descriptions herein can apply to either definition.

### 4. Residuals, Transforms, and Quantization

A residual block consists of samples that represents sample value differences between sample values of the original source blocks and the prediction blocks. The residual block is processed using a spatial transform. In the encoder, the transform coefficients are quantized according to a quantization parameter (QP) which controls the precision of the quantized coefficients. The quantized coefficients can be referred to as residual coefficients. A high QP value would result in low precision of the coefficients and thus low fidelity of the residual block. A decoder receives the residual coefficients, applies inverse quantization and inverse transform to derive the residual block.

### 5. NAL Units

Both HEVC and VVC define a Network Abstraction Layer (NAL). All the data, i.e. both Video Coding Layer (VCL) or non-VCL data in HEVC and VVC is encapsulated in NAL units. A VCL NAL unit contains data that represents picture sample values. A non-VCL NAL unit contains additional associated data such as parameter sets and supplemental enhancement information (SEI) messages. The NAL unit in HEVC begins with a header which specifies the NAL unit type of the NAL unit that identifies what type of data is carried in the NAL unit, the layer ID and the temporal ID for which the NAL unit belongs to. The NAL unit type is transmitted in the nal_unit_type codeword in the NAL unit header and the type indicates and defines how the NAL unit should be parsed and decoded. The rest of the bytes of the NAL unit is payload of the type indicated by the NAL unit type. A bitstream consists of a series of concatenated NAL units.

The syntax for the NAL unit header for HEVC is shown in Table 1.

TABLE 1
HEVC NAL unit header syntax

| | Descriptor |
|---|---|
| nal_unit_header( ) { | |
| forbidden_zero_bit | f(1) |
| nal_unit_type | u(6) |
| nuh_layer_id | u(6) |
| nuh_temporal_id_plus1 | u(3) |
| } | |

The syntax for the NAL unit header in the current version of VVC is shown in Table 2.

TABLE 2
VVC NAL unit header syntax

| | Descriptor |
|---|---|
| nal_unit_header( ) { | |
| forbidden_zero_bit | f(1) |
| nuh_reserved_zero_bit | u(1) |
| nuh_layer_id | u(6) |
| nal_unit_type | u(5) |
| nuh_temporal_id_plus1 | u(3) |
| } | |

The NAL unit types of the current version of VVC are shown in Table 3.

The decoding order is the order in which NAL units shall be decoded, which is the same as the order of the NAL units within the bitstream. The decoding order may be different from the output order, which is the order in which decoded pictures are to be output, such as for display, by the decoder.

TABLE 3
NAL unit types in VVC

| | Name of | | NAL unit |
|---|---|---|---|
| nal_unit_type | nal_unit_type | Content of NAL unit and RBSP syntax structure | type class |
| 0 | TRAIL_NUT | Coded slice of a trailing picture or subpicture* | VCL |
| | | slice_layer_rbsp( ) | |
| 1 | STSA_NUT | Coded slice of an STSA picture or subpicture* | VCL |
| | | slice_layer_rbsp( ) | |
| 2 | RADL_NUT | Coded slice of a RADL picture or subpicture* | VCL |
| | | slice_layer_rbsp( ) | |
| 3 | RASL_NUT | Coded slice of a RASL picture or subpicture* | VCL |
| | | slice_layer_rbsp( ) | |
| 4 . . . 6 | RSV_VCL_4 . . . | Reserved non-IRAP VCL NAL unit types | VCL |
| | RSV_VCL_6 | | |
| 7 | IDR_W_RADL | Coded slice of an IDR picture or subpicture* | VCL |
| 8 | IDR_N_LP | slice_layer_rbsp( ) | |
| 9 | CRA_NUT | Coded slice of a CRA picture or subpicture* | VCL |
| | | slice_layer_rbsp( ) | |
| 10 | GDR_NUT | Coded slice of a GDR picture or subpicture* | VCL |
| | | slice_layer_rbsp( ) | |
| 11 | RSV_IRAP_11 | Reserved IRAP VCL NAL unit type | VCL |
| 12 | OPI_NUT | Operating point inforamtion | non-VCL |
| | | operating_point_information_rbsp( ) | |
| 13 | DCI_NUT | Decoding capability information | non-VCL |
| | | decoding_capability_information_rbsp( ) | |
| 14 | VPS_NUT | Video parameter set | non-VCL |
| | | video_parameter_set_rbsp( ) | |
| 15 | SPS_NUT | Sequence parameter set | non-VCL |
| | | seq_parameter_set_rbsp( ) | |
| 16 | PPS_NUT | Picture parameter set | non-VCL |
| | | pic_parameter_set_rbsp( ) | |
| 17 | PREFIX_APS_NUT | Adaptation parameter set | non-VCL |
| 18 | SUFFIX_APS_NUT | adaptation_parameter_set_rbsp( ) | |
| 19 | PH_NUT | Picture header | non-VCL |
| | | picture_header_rbsp( ) | |
| 20 | AUD_NUT | AU delimiter | non-VCL |
| | | access_unit_delimiter_rbsp( ) | |
| 21 | EOS_NUT | End of sequence | non-VCL |
| | | end_of_seq_rbsp( ) | |
| 22 | EOB_NUT | End of bitstream | non-VCL |
| | | end_of_bitstream_rbsp( ) | |
| 23 | PREFIX_SEI_NUT | Supplemental enhancement information | non-VCL |
| 24 | SUFFIX_SEI_NUT | sei_rbsp( ) | |
| 25 | FD_NUT | Filler data | non-VCL |
| | | filler_data_rbsp( ) | |
| 26 | RSV_NVCL_26 | Reserved non-VCL NAL unit types | non-VCL |
| 27 | RSV_NVCL_27 | | |
| 28 . . . 31 | UNSPEC_28 . . . | Unspecified non-VCL NAL unit types | non-VCL |
| | UNSPEC_31 | | |

*indicates a property of a picture when pps_mixed_nalu_types_in_pic_flag is equal to 0 and a property of the subpicture when pps_mixed_nalu_types_in_pic_flag is equal to 1.

### 6. Temporal Layers

In HEVC and VVC all pictures are associated with a TemporalId value that specifies the temporal layer to which the picture belongs. TemporalId values are decoded from the nuh_temporal_id_plus1 syntax element in the NAL unit header. The encoder is required to set TemporalId values such that pictures belonging to a lower layer is perfectly decodable when higher temporal layers are discarded. Assume for instance that an encoder has output a bitstream using temporal layers 0, 1 and 2. Then removing all layer 2 NAL units or removing all layer 1 and 2 NAL units will result in bitstreams that can be decoded without problems. This is ensured by restrictions in the HEVC specification with which the encoder must comply. For instance, it is not allowed for a picture of a temporal layer to reference a picture of a higher temporal layer.

### 7. Layer Id

The value of the nuh_layer_id syntax element in the NAL unit header specifies the layer ID to which the NAL unit belongs. A layer access unit in VVC is defined as a set of one or more NAL units for which the VCL NAL units all have a particular value of nuh_layer_id, that are associated with each other according to a specified classification rule, that are consecutive in decoding order, and that contain exactly one coded picture.

A coded layer video sequence (CLVS) in VVC version 1 is defined as a sequence of layer access units that consists, in decoding order, of a CLVS layer access unit, followed by zero or more layer access units that are not CLVS layer access units, including all subsequent layer access units up to but not including any subsequent layer access unit that is a CLVS layer access unit. The relation between the layer access units and coded layer video sequences is illustrated in FIG. 1A.

In VVC version 1, layers may be coded independently or dependently from each other. When the layers are coded independently, a layer with, for example, nuh_layer_id 0 may not predict video data from another layer with e.g. nuh_layer_id 1. In VVC version 1, dependent coding between layers may be used, which enables support for scalable coding with SNR, spatial and view scalability.

### 8. Picture Header

VVC includes a picture header, which is a NAL unit having nal_unit_type equal to PH_NUT. The picture header is similar to the slice header, but the values of the syntax elements in the picture header are used to decode all slices of one picture. Each picture in VVC consist of one picture header NAL unit followed by all coded slices of the picture where each coded slice is conveyed in one coded slice NAL unit.

### 9. Intra Random Access Point (IRAP) Pictures and the Coded Video Sequence (CVS)

For single layer coding in HEVC, an access unit (AU) is the coded representation of a single picture. An AU may consist of several video coding layer (VCL) NAL units as well as non-VCL NAL units.

An Intra Random Access Point (IRAP) picture in HEVC is a picture that does not refer to any pictures other than itself for prediction in its decoding process. The first picture in the bitstream in decoding order in HEVC must be an IRAP picture, but an IRAP picture may additionally also appear later in the bitstream. HEVC specifies three types of IRAP pictures, the broken link access (BLA) picture, the instantaneous decoder refresh (IDR) picture, and the clean random access (CRA) picture.

A coded video sequence (CVS) in HEVC is a series of access units starting at an IRAP access unit up to, but not including the next IRAP access unit in decoding order.

IDR pictures always start a new CVS. An IDR picture may have associated random access decodable leading (RADL) pictures. An IDR picture does not have associated RASL pictures.

BLA pictures also starts a new CVS and has the same effect on the decoding process as an IDR picture. However, a BLA picture in HEVC may contain syntax elements that specify a non-empty set of one or more reference pictures. A BLA picture may have associated RASL pictures, which are not output by the decoder and may not be decodable, as they may contain references to pictures that may not be present in the bitstream. A BLA picture may also have associated RADL pictures, which are decoded.

A CRA picture may have associated RADL or RASL pictures. As with a BLA picture, a CRA picture may contain syntax elements that specify a non-empty set of one or more reference pictures. For CRA pictures, a flag can be set to specify that the associated RASL pictures are not output by the decoder, because they may not be decodable, as they may contain references to pictures that are not present in the bitstream. A CRA may or may not start a CVS.

In VVC, there is also the GRA picture which may or may not start a CVS without an Intra picture. A coded layer video sequence start (CLVSS) picture in VVC is an IRAP picture or a GRA picture. A CLVSS picture in VVC may start a VVC coded layer video sequence (CLVS) which is similar to a CVS in HEVC. There is no BLA picture type in VVC.

### 10. Parameter Sets

HEVC specifies three types of parameter sets, the picture parameter set (PPS), the sequence parameter set (SPS) and the video parameter set (VPS). The PPS contains data that is common for a whole picture, the SPS contains data that is common for a coded video sequence (CVS) and the VPS contains data that is common for multiple CVSs.

VVC also uses parameter set types of HEVC. In VVC, there is also the adaptation parameter set (APS) and the decoding parameter set (DPS). The APS may contain information that can be used for multiple slices and two slices of the same picture can use different APSes. The DPS consist of information specifying the “worst case” in terms of profile and level that the decoder will encounter in the entire bitstream.

### 11. SEI Messages

Supplementary Enhancement Information (SEI) messages are codepoints in the coded bitstream that do not influence the decoding process of coded pictures from VCL NAL units. SEI messages usually address issues of representation/rendering of the decoded bitstream. The overall concept of SEI messages and many of the messages themselves have been inherited from the H.264 and HEVC specifications into the VVC specification. In VVC, an SEI RBSP contains one or more SEI messages.

SEI message syntax table describing the general structure of an SEI message in VVC is shown in Table 4. The type of each SEI message is identified by its payload type.

TABLE 4
SEI message syntax in VVC

| | Descriptor |
|---|---|
| sei_message( ) { | |
| payloadType = 0 | |
| do { | |
| payload_type_byte | u(8) |
| payloadType += payload_type_byte | |
| } while( payload_type_byte == 0xFF ) | |
| payloadSize = 0 | |
| do { | |
| payload_size_byte | u(8) |
| payloadSize += payload_size_byte | |
| } while( payload_size_byte = = 0xFF ) | |
| sei_payload( payloadType, payloadSize ) | |
| } | |

Annex D in the VVC specification specifies syntax and semantics for SEI message payloads for some SEI messages, and specifies the use of the SEI messages and VUI parameters for which the syntax and semantics are specified in ITU-T H.SEI|ISO/IEC 23002-7. The SEI payload structure in Annex D of VVC version 1 lists the SEI messages supported in VVC version 1. Table 5 shows general SEI payload syntax in VVC version 1 where the SEI payload is the container of SEI messages.

TABLE 5
General SEI payload syntax in VVC version 1

| | Descriptor |
|---|---|
| sei_payload( payloadType, payloadSize ) { | |
| if( nal_unit_type = = PREFIX_SEI_NUT ) | |
| if( payloadType = = 0) | |
| buffering_period( payloadSize ) | |
| else if( payloadType = = 1 ) | |
| pic_timing( payloadSize ) | |
| else if( payloadType = = 3 ) | |
| filler_payload( payloadSize ) /* Specified in Rec. ITU-T H.274 \| ISO/IEC 23002-7 */ | |
| else if( payloadType = = 4 ) /* Specified in Rec. ITU-T H.274 \| ISO/IEC 23002-7 */ | |
| user_data_registered_itu_t_t35( payloadSize ) | |
| else if( payloadType = = 5 ) /* Specified in Rec. ITU-T H.274 \| ISO/IEC 23002-7 */ | |
| user_data_unregistered( payloadSize ) | |
| else if( payloadType = = 19 ) /* Specified in Rec. ITU-T H.274 \| ISO/IEC 23002-7 */ | |
| film_grain_characteristics( payloadSize ) | |
| else if( payloadType = = 45 ) /* Specified in Rec. ITU-T H.274 \| ISO/IEC 23002-7 */ | |
| frame_packing_arrangement( payloadSize ) | |
| else if( payloadType = = 129) /* Specified in Rec. ITU-T H.274 \| ISO/IEC 23002-7 */ | |
| parameter_sets_inclusion_indication( payloadSize ) | |
| else if( payloadType = = 130 ) | |
| decoding_unit_info( payloadSize ) | |
| else if( payloadType = = 133 ) | |
| scalable_nesting( payloadSize ) | |
| else if( payloadType = = 137) /* Specified in Rec. ITU-T H.274 \| ISO/IEC 23002-7 */ | |
| mastering_display_colour_volume( payloadSize ) | |
| else if( payloadType = = 144 ) /* Specified in Rec. ITU-T H.274 \| ISO/IEC 23002-7 */ | |
| content_light_level_info( payloadSize ) | |
| else if( payloadType = = 145 ) /* Specified in Rec. ITU-T H.274 \| ISO/IEC 23002-7 */ | |
| dependent_rap_indication( payloadSize ) | |
| else if( payloadType = = 147 ) /* Specified in Rec. ITU-T H.274 \| ISO/IEC 23002-7 */ | |
| alternative_transfer_characteristics( payloadSize ) | |
| else if( payloadType = = 148 ) /* Specified in Rec. ITU-T H.274 \| ISO/IEC 23002-7 */ | |
| ambient_viewing_environment( payloadSize ) | |
| else if( payloadType = = 149) /* Specified in Rec. ITU-T H.274 \| ISO/IEC 23002-7 */ | |
| content_colour_volume( payloadSize ) | |
| else if( payloadType = = 150 ) /* Specified in Rec. ITU-T H.274 \| ISO/IEC 23002-7 */ | |
| equirectangular_projection( payloadSize ) | |
| else if( payloadType = = 153 ) /* Specified in Rec. ITU-T H.274 \| ISO/IEC 23002-7 */ | |
| generalized_cubemap_projection( payloadSize ) | |
| else if( payloadType = = 154 ) /* Specified in Rec. ITU-T H.274 \| ISO/IEC 23002-7 */ | |
| sphere_rotation( payloadSize ) | |
| else if( payloadType = = 155 ) /* Specified in Rec. ITU-T H.274 \| ISO/IEC 23002-7 */ | |
| regionwise_packing( payloadSize ) | |
| else if( payloadType = = 156 ) /* Specified in Rec. ITU-T H.274 \| ISO/IEC 23002-7 */ | |
| omni_viewport( payloadSize ) | |
| else if( payloadType = = 168 ) /* Specified in Rec. ITU-T H.274 \| ISO/IEC 23002-7 */ | |
| frame_field_info( payloadSize ) | |
| else if( payloadType = = 203 ) | |
| subpic_level_info( payloadSize ) | |
| else if( payloadType = = 204 ) /* Specified in Rec. ITU-T H.274 \| ISO/IEC 23002-7 */ | |
| sample_aspect_ratio_info( payloadSize ) | |
| else /* Specified in Rec. ITU-T H.274 \| ISO/IEC 23002-7 */ | |
| reserved_message( payloadSize ) | |
| else /* nal_unit_type = = SUFFIX SEI NUT */ | |
| if( payloadType = = 3 ) /* Specified in Rec. ITU-T H.274 \| ISO/IEC 23002-7 */ | |
| filler_payload( payloadSize ) | |
| if( payloadType = = 132 ) /* Specified in Rec. ITU-T H.274 \| ISO/IEC 23002-7 */ | |
| decoded picture_hash( payloadSize ) | |
| else if( payloadType = = 133 ) | |
| scalable_nesting( payloadSize ) | |
| else /* Specified in Rec. ITU-T H.274 \| ISO/IEC 23002-7 */ | |
| reserved_message( payloadSize ) | |
| if( more_data_in_payload( ) ) { | |
| if( payload_extension_present( ) ) | |
| sei_reserved_payload_extension_data | u(v) |
| sei_payload_bit_equal_to_one /* equal to 1 */ | f(1) |
| while( !byte_aligned( ) ) | |
| sei_payload_bit_equal_to_zero /* equal to 0 */ | f(1) |
| } | |
| } | |

SEI messages assist in processes related to decoding, display or other purposes. However, SEI messages are not required for constructing the luma or chroma samples by the decoding process. Some SEI messages are required for checking bitstream conformance and for output timing decoder conformance. Other SEI messages are not required for checking bitstream conformance. A decoder is not required to support all SEI messages. Usually, if a decoder encounters an unsupported SEI message, it is discarded.

ITU-T H.274|ISO/IEC 23002-7, also referred to as VSEI, specifies the syntax and semantics of SEI messages and is particularly intended for use with coded video bitstreams, although it is written in a manner intended to be sufficiently generic that it may also be used with other types of coded video bitstreams. The first version of ITU-T H.274 ISO/IEC 23002-7 was finalized in July 2020. At the time of writing, version 2 is under development. JVET-U2006-v1 is the current draft for version 2 that specifies additional SEI messages for use with coded video bitstreams.

The persistence of an SEI message indicates the pictures to which the values signalled in the instance of the SEI message may apply. The part of the bitstream that the values of the SEI message may apply to are referred to as the persistence scope of the SEI message.

### 12. Persistence Scope of SEI Messages

A persistence scope is associated with each SEI message which specifies the scope of the bitstream that the SEI message applies to. Table 6 describes the persistence scope of the SEI messages defined in VVC version 1 and Table 7 describes the persistence scope of the SEI messages defined in VSEI.

TABLE 6
Persistence scope of SEI messages defined in VVC version 1

| SEI message | Persistence scope |
|---|---|
| Buffering period | The remainder of the bitstream |
| Picture timing | The AU containing the SEI message |
| DU information | The AU containing the SEI message |
| Scalable nesting | Depending on the scalable-nested SEI messages. Each scalable-nested |
| | SEI message has the same persistence scope as if the SEI message was |
| | not scalable-nested |
| Subpicture level information | The CVS containing the SLI SEI message and up to but not including |
| | the next CVS, in decoding order, that contains an SLI SEI message |
| | with different content |

TABLE 7
Persistence scope of SEI messages defined in VSEI.

| SEI message | Persistence scope |
|---|---|
| Filler payload | The PU containing the SEI message |
| User data registered by Rec. ITU-T | Unspecified |
| T.35 | |
| User data unregistered | Unspecified |
| Film grain characteristics | Specified by the syntax of the SEI message |
| Frame packing arrangement | Specified by the syntax of the SEI message |
| Referenced parameter sets | The CL VS containing the SEI message |
| Decoded picture hash | The PU containing the SEI message |
| Mastering display colour volume | The CL VS containing the SEI message |
| Content light level information | The CL VS containing the SEI message |
| DRAP indication | The PU containing the SEI message |
| Alternative transfer characteristics | The CL VS containing the SEI message |
| Ambient viewing environment | The CL VS containing the SEI message |
| Content colour volume | Specified by the syntax of the SEI message |
| Equirectangular projection | Specified by the syntax of the SEI message |
| Generalized cubemap projection | Specified by the syntax of the SEI message |
| Sphere rotation | Specified by the syntax of the SEI message |
| Region-wise packing | Specified by the syntax of the SEI message |
| Omnidirectional viewport | Specified by the syntax of the SEI message |
| Frame-field information | The PU containing the SEI message |
| Sample aspect ratio information | Specified by the syntax of the SEI message |

### 13. Tiles

The current version of VVC includes a tool called tiles that divides a picture into rectangular spatially independent regions. Tiles in the VVC coding standard are similar to the tiles used in HEVC. Using tiles, a picture in VVC can be partitioned into rows and columns of CTUs where a tile is an intersection of a row and a column. FIG. 1B shows an example of a tile partitioning using 4 tile rows and 5 tile columns resulting in a total of 20 tiles for the picture.

The tile structure is signalled in the picture parameter set (PPS) by specifying the heights of the rows and the widths of the columns. Individual rows and columns can have different sizes, but the partitioning always spans across the entire picture, from left to right and top to bottom respectively.

There is no decoding dependency between tiles of the same picture. This includes intra prediction, context selection for entropy coding and motion vector prediction. One exception is that in-loop filtering dependencies are generally allowed between tiles.

In the rectangular slice mode in VVC, a tile can further be split into multiple slices where each slice consists of a consecutive number of CTU rows inside one tile. FIG. 1C shows an example of tile partitioning and FIG. 1D shows an example of a rectangular slice partitioning using the tile partitioning of FIG. 1C.

### 14. Slices

The concept of slices in HEVC divides the picture into independently coded slices, where decoding of one slice in a picture is independent of other slices of the same picture. Different coding types could be used for slices of the same picture, i.e. a slice could either be an I-slice, P-slice or B-slice. One purpose of slices is to enable resynchronization in case of data loss. In HEVC, a slice is a set of one or more CTUs.

In the current version of VVC, a slice is defined as an integer number of complete tiles or an integer number of consecutive complete CTU rows within a tile of a picture that are exclusively contained in a single NAL unit. A picture may be partitioned into either raster scan slices or rectangular slices. A raster scan slice consists of a number of complete tiles in raster scan order. A rectangular slice consists of a group of tiles that together occupy a rectangular region in the picture or a consecutive number of CTU rows inside one tile. Each slice has a slice header comprising syntax elements. Decoded slice header values from these syntax elements are used when decoding the slice. Each slice is carried in one VCL NAL unit. In an early version of the VVC draft specification, slices were referred to as tile groups. In the current version of VVC, the partition layout of the rectangular slices is signalled in the PPS as described in Table 8.

TABLE 8
Syntax for the partition layout of rectangular slices in the PPS current version of VVC.

| | Descriptor |
|---|---|
| pic_parameter_set_rbsp( ) { | |
| ... | |
| pps_no_pic_partition_flag | u(1) |
| ... | |
| if( !pps_no_pic_partition_flag ) { | |
| pps_log2_ctu_size_minus5 | u(2) |
| pps_num_exp_tile_columns_minus1 | ue(v) |
| pps_num_exp_tile_rows_minus1 | ue(v) |
| for( i= 0; i <= pps_num_exp_tile_columns_minus1; i++ ) | |
| pps_tile_column_width_minus1 [ i ] | ue(v) |
| for( i= 0; i <= pps_num_exp_tile_rows_minus1; i++ ) | |
| pps_tile_row_height_minus1 [ i] | ue(v) |
| if( NumTilesInPic > 1 ) { | |
| pps_loop_filter_across_tiles_enabled_flag | u(1) |
| pps_rect_slice_flag | u(1) |
| } | |
| if( pps_rect_slice_flag ) | |
| pps_single_slice_per_subpic_flag | u(1) |
| if( pps_rect_slice_flag && !pps_single_slice_per_subpic_flag ) { | |
| pps_num_slices_in_pic_minus1 | ue(v) |
| if( pps_num_slices_in_pic_minus1 > 1) | |
| pps_tile_idx_delta_present_flag | u(1) |
| for( i= 0; i < pps_num_slices_in_pic_minus1; i++ ) { | |
| if( SliceTopLeftTileIdx[ i ] % NumTileColumns != NumTileColumns − 1 ) | |
| pps_slice_width_in_tiles_minus1 [ i] | ue(v) |
| if( SliceTopLeftTileIdx[ i ] / NumTileColumns != NumTileRows − 1 && | |
| ( pps_tile_idx_delta present_flag \| \| | |
| Slice TopLeftTileIdx[ i ] % NumTileColumns = = 0) ) | |
| pps_slice_height_in_tiles_minus1 [ i ] | ue(v) |
| if( pps_slice_width_in_tiles minus1[ i ] = = 0 && | |
| pps_slice_height_in_tiles_minus1 [ i ] = = 0 && | |
| RowHeightVal[ SliceTopLeftTileIdx[ i ] / NumTileColumns ] > 1 ) { | |
| pps_num_exp_slices_in_tile[ i ] | ue(v) |
| for( j = 0; j < pps_num_exp_slices_in_tile[ i ]; j++ ) | |
| pps_exp_slice_height_in_ctus_minus1[ i ][ j ] | ue(v) |
| i += NumSlicesInTile[ i ] − 1 | |
| } | |
| if( pps_tile_idx_delta present_flag && i <pps_num_slices_in_pic_minus1 ) | |
| pps_tile_idx_delta_val[ i ] | se(v) |
| } | |
| } | |
| if( !pps_rect_slice_flag \| \| pps_single_slice_per_subpic_flag \| \| | |
| pps_num_slices_in_pic_minus1 > 0 ) | |
| pps_loop_filter_across_slices_enabled_flag | u(1) |
| } | |
| ... | |
| } | |

The semantics for the syntax elements in Table 8 are given below.

pps_no_pic_partition_flag equal to 1 specifies that no picture partitioning is applied to each picture referring to the PPS. pps_no_pic_partition_flag equal to 0 specifies that each picture referring to the PPS might be partitioned into more than one tile or slice. When sps_num_subpics_minus1 is greater than 0 or pps_mixed_nalu_types_in_pic_flag is equal to 1, the value of pps_no_pic_partition_flag shall be equal to 0.

pps_log2_ctu_size_minus5 plus 5 specifies the luma coding tree block size of each CTU. pps_log2_ctu_size_minus5 shall be equal to sps_log2_ctu_size_minus5.

pps_num_exp_tile_columns_minus1 plus 1 specifies the number of explicitly provided tile column widths. The value of pps_num_exp_tile_columns_minus1 shall be in the range of 0 to PicWidthInCtbsY−1, inclusive. When pps_no_pic_partition_flag is equal to 1, the value of pps_num_exp_tile_columns_minus1 is inferred to be equal to 0.

pps_num_exp_tile_rows_minus1 plus 1 specifies the number of explicitly provided tile row heights. The value of pps_num_exp_tile_rows_minus1 shall be in the range of 0 to PicHeightInCtbsY−1, inclusive. When pps_no_pic_partition_flag is equal to 1, the value of num_tile_rows_minus1 is inferred to be equal to 0.

pps_tile_column_width_minus1[i] plus 1 specifies the width of the i-th tile column in units of CTBs for i in the range of 0 to pps_num_exp_tile_columns_minus1, inclusive. pps_tile_column_width_minus1[pps_num_exp_tile_columns_minus1] is also used to derive the widths of the tile columns with index greater than pps_num_exp_tile_columns_minus1 as specified in clause 6.5.1 of the above-referenced VVC specification. The value of pps_tile_column_width_minus1[i] shall be in the range of 0 to PicWidthInCtbsY−1, inclusive. When not present, the value of pps_tile_column_width_minus1[0] is inferred to be equal to PicWidthInCtbsY−1.

pps_tile_row_height_minus1[i] plus 1 specifies the height of the i-th tile row in units of CTBs for i in the range of 0 to pps_num_exp_tile_rows_minus1, inclusive. pps_tile_row_height_minus1[pps_num_exp_tile_rows_minus1] is also used to derive the heights of the tile rows with index greater than pps_num_exp_tile_rows_minus1 as specified in clause 6.5.1 of the above-referenced VVC specification. The value of pps_tile_row_height_minus1[i] shall be in the range of 0 to PicHeightInCtbsY−1, inclusive. When not present, the value of pps_tile_row_height_minus1[0] is inferred to be equal to PicHeightInCtbsY−1.

pps_loop_filter_across_tiles_enabled_flag equal to 1 specifies that in-loop filtering operations across tile boundaries are enabled for pictures referring to the PPS. pps_loop_filter_across_tiles_enabled_flag equal to 0 specifies that in-loop filtering operations across tile boundaries are disabled for pictures referring to the PPS. The in-loop filtering operations include the deblocking filter, SAO, and ALF operations. When not present, the value of pps_loop_filter_across_tiles_enabled_flag is inferred to be equal to 0.

pps_rect_slice_flag equal to 0 specifies that the raster-san slice mode is in use for each picture referring to the PPS and the slice layout is not signalled in PPS. pps_rect_slice_flag equal to 1 specifies that the rectangular slice mode is in use for each picture referring to the PPS and the slice layout is signalled in the PPS. When not present, the value of pps_rect_slice_flag is inferred to be equal to 1. When sps_subpic_info_present_flag is equal to 1 or pps_mixed_nalu_types_in_pic_flag is equal to 1, the value of pps_rect_slice_flag shall be equal to 1.

pps_single_slice_per_subpic_flag equal to 1 specifies that each subpicture consists of one and only one rectangular slice. pps_single_slice_per_subpic_flag equal to 0 specifies that each subpicture could consist of one or more rectangular slices. When pps_no_pic_partition_flag is equal to 1, the value of pps_single_slice_per_subpic_flag is inferred to be equal to 1. Note 4—when there is only one subpicture per picture, pps_single_slice_per_subpic_flag equal to 1 means that there is only one slice per picture.

pps_num_slices_in_pic_minus1 plus 1 specifies the number of rectangular slices in each picture referring to the PPS. The value of pps_num_slices_in_pic_minus1 shall be in the range of 0 to MaxSlicesPerAu−1, inclusive, where MaxSlicesPerAu is specified in Annex A of the above-referenced VVC specification. When pps_no_pic_partition_flag is equal to 1, the value of pps_num_slices_in_pic_minus1 is inferred to be equal to 0. When pps_single_slice_per_subpic_flag is equal to 1, the value of pps_num_slices_in_pic_minus1 is inferred to be equal to sps_num_subpics_minus1.

pps_tile_idx_delta_present_flag equal to 0 specifies that pps_tile_idx_delta_val[i] syntax elements are not present in the PPS and all pictures referring to the PPS are partitioned into rectangular slice rows and rectangular slice columns in slice raster order. pps_tile_idx_delta_present_flag equal to 1 specifies that pps_tile_idx_delta_val[i] syntax elements could be present in the PPS and all rectangular slices in pictures referring to the PPS are specified in the order indicated by the values of the pps_tile_idx_delta_val[i] in increasing values of i. When not present, the value of pps_tile_idx_delta_present_flag is inferred to be equal to 0.

pps_slice_width_in_tiles_minus1[i] plus 1 specifies the width of the i-th rectangular slice in units of tile columns. The value of pps_slice_width_in_tiles_minus1[i] shall be in the range of 0 to NumTileColumns−1, inclusive. When not present, the value of pps_slice_width_in_tiles_minus1[i] is inferred to be equal to 0.

pps_slice_height_in_tiles_minus1[i] plus 1 specifies the height of the i-th rectangular slice in units of tile rows when pps_num_exp_slices_in_tile[i] is equal to 0. The value of pps_slice_height_in_tiles_minus1[i] shall be in the range of 0 to NumTileRows−1, inclusive.

When pps_slice_height_in_tiles_minus1[i] is not present, it is inferred as follows: If SliceTopLeftTileIdx[i]/NumTileColumns is equal to NumTileRows−1, the value of pps_slice_height_in_tiles_minus1[i] is inferred to be equal to 0; Otherwise, the value of pps_slice_height_in_tiles_minus1[i] is inferred to be equal to pps_slice_height_in_tiles_minus1[i−1].

pps_num_exp_slices_in_tile[i] specifies the number of explicitly provided slice heights for the slices in the tile containing the i-th slice (i.e., the tile with tile index equal to SliceTopLeftTileIdx[i]). The value of pps_num_exp_slices_in_tile[i] shall be in the range of 0 to RowHeightVal[SliceTopLeftTileIdx[i]/NumTileColumns]−1, inclusive. When not present, the value of pps_num_exp_slices_in_tile[i] is inferred to be equal to 0. If pps_num_exp_slices_in_tile[i] is equal to 0, the tile containing the i-th slice is not split into multiple slices. Otherwise (pps_num_exp_slices_in_tile[i] is greater than 0), the tile containing the i-th slice might or might not be split into multiple slices.

pps_exp_slice_height_in_ctus_minus1[i][j] plus 1 specifies the height of the j-th rectangular slice in the tile containing the i-th slice, in units of CTU rows, for j in the range of 0 to pps_num_exp_slices_in_tile[i]−1, inclusive, when pps_num_exp_slices_in_tile[i] is greater than 0. pps_exp_slice_height_in_ctus_minus1[i] [pps_num_exp_slices_in_tile[i] ] is also used to derive the heights of the rectangular slices in the tile containing the i-th slice with index greater than pps_num_exp_slices_in_tile[i]−1 as specified in clause 6.5.1 of the above-referenced VVC specification. The value of pps_exp_slice_height_in_ctus_minus1[i][j] shall be in the range of 0 to RowHeightVal[SliceTopLeftTileIdx[i]/NumTileColumns]−1, inclusive.

pps_tile_idx_delta_val[i] specifies the difference between the tile index of the tile containing the first CTU in the (i+1)-th rectangular slice and the tile index of the tile containing the first CTU in the i-th rectangular slice. The value of pps_tile_idx_delta_val[i] shall be in the range of −NumTilesInPic+1 to NumTilesInPic−1, inclusive. When not present, the value of pps_tile_idx_delta_val[i] is inferred to be equal to 0. When present, the value of pps_tile_idx_delta_val[i] shall not be equal to 0. When pps_rect_slice_flag is equal to 1, it is a requirement of bitstream conformance that, for any two slices, with picture-level slice indices idxA and idxB, that belong to the same picture and different subpictures, when SubpicIdxForSlice[idxA] is less than SubpicIdxForSlice[idxB], the value of idxA shall be less than idxB.

pps_loop_filter_across_slices_enabled_flag equal to 1 specifies that in-loop filtering operations across slice boundaries are enabled for pictures referring to the PPS. loop_filter_across_slice_enabled_flag equal to 0 specifies that in-loop filtering operations across slice boundaries are disabled for the PPS. The in-loop filtering operations include the deblocking filter, SAO, and ALF operations. When not present, the value of pps_loop_filter_across_slices_enabled_flag is inferred to be equal to 0.

### 14.1 Subpictures

Subpictures are supported in the current version of VVC. A Subpicture in VVC is defined as a rectangular region of one or more slices within a picture. This means a subpicture contains one or more slices that collectively cover a rectangular region of a picture.

In the current version of VVC, subpicture location and size are signalled in the SPS. Boundaries of a subpicture region may be treated as picture boundaries (excluding in-loop filtering operations) conditioned to a per-subpicture flag sps_subpic_treated_as_pic_flag[i] in the SPS. Also loop-filtering on subpicture boundaries is conditioned to a per-subpicture flag sps_loop_filter_across_subpic_enabled_flag[i] in the SPS.

There is also a subpicture ID mapping mechanism signalled in the SPS or in the PPS for the subpictures which is gated by two flags in SPS sps_subpic_id_present_flag and sps_subpic_id_signalling_present_flag and a flag in PPS pps_subpic_id_mapping_present_flag. The subpicture ID mapping mechanism maps each subpicture ID of a picture associated with the SPS/PPS to an index describing the bitstream order of the subpictures in the picture. This mechanism enables bitstream extraction and merger operations to be performed without having to rewrite the subpicture ID signalled in each slice, only the SPS/PPS may need to be rewritten.

Table 9 shows the subpicture syntax in the SPS in the current version of VVC. In Table 9 variable i is the subpicture index and the syntax elements for subpicture position, size and other properties are signalled for each subpicture in the order of subpicture index. For instance, all the syntax elements with i equal to 0 specify position, size and other properties of a subpicture with subpicture index equal to 0.

TABLE 9
Subpicture syntax in the SPS (current version of the VVC)

| | Descriptor |
|---|---|
| seq_parameter_set_rbsp( ) { | |
| ... | |
| sps_subpic_info_present_flag | u(1) |
| if( sps_subpic_info_present_flag ) { | |
| sps_num_subpics_minus1 | ue(v) |
| if( sps_num_subpics_minus1 > 0 ) { | |
| sps_independent_subpics_flag | u(1) |
| sps_subpic_same_size_flag | u(1) |
| } | |
| for( i = 0; sps_num_subpics_minus1 > 0 && i <= sps_num_subpics_minus1; i++ ) { | |
| if( !sps_subpic_same_size_flag \| \| i = = 0 ) { | |
| if(i>0 && sps_pic_width_max_in_luma_samples > CtbSizeY ) | |
| sps_subpic_ctu_top_left_x[ i ] | u(v) |
| if( i>0 && sps_pic_height_max_in_luma_samples > CtbSizeY ) | |
| sps_subpic_ctu_top_left y[ i ] | u(v) |
| if( i < sps_num_subpics_minus1 && | |
| sps_pic_width_max_in luma samples > CtbSizeY ) | |
| sps_subpic_width_minus1 [ i ] | u(v) |
| if( i < sps_num_subpics_minus1 && | |
| sps_pic_height_max_in_luma_samples > CtbSize Y ) | |
| sps_subpic_height_minus1 [ i ] | u(v) |
| } | |
| if( !sps_independent_subpics_flag) { | |
| sps_subpic_treated_as_pic_flag[ i ] | u(1) |
| sps_loop_filter_across_subpic_enabled_flag[ i ] | u(1) |
| } | |
| } | |
| sps_subpic_id_len_minus1 | ue(v) |
| sps_subpic_id_mapping_explicitly_signalled_flag | u(1) |
| if( sps_subpic_id_mapping_explicitly_signalled_flag ) { | |
| sps_subpic_id_mapping_present_flag | u(1) |
| if( sps_subpic_id_mapping_present_flag ) | |
| for( i= 0; i <= sps_num_subpics_minus1; i++ ) | |
| sps_subpic_id[ i ] | u(v) |
| } | |
| } | |
| ... | |
| } | |

The semantics regarding syntax elements in Table 9 are given below

sps_subpic_info_present_flag equal to 1 specifies that subpicture information is present for the CLVS and there might be one or more than one subpicture in each picture of the CLVS. sps_subpic_info_present_flag equal to 0 specifies that subpicture information is not present for the CLVS and there is only one subpicture in each picture of the CLVS. When sps_res_change_in_clvs_allowed_flag is equal to 1, the value of sps_subpic_info_present_flag shall be equal to 0. Note 5—when a bitstream is the result of a subpicture sub-bitstream extraction process and contains only a subset of the subpictures of the input bitstream to the subpicture sub-bitstream extraction process, it might be required to set the value of sps_subpic_info_present_flag equal to 1 in the RBSP of the SPSs.

sps_num_subpics_minus1 plus 1 specifies the number of subpictures in each picture in the CLVS. The value of sps_num_subpics_minus1 shall be in the range of 0 to MaxSlicesPerAu−1, inclusive, where MaxSlicesPerAu is specified in Annex A of the above-referenced VVC specification. When not present, the value of sps_num_subpics_minus1 is inferred to be equal to 0.

sps_independent_subpics_flag equal to 1 specifies that all subpicture boundaries in the CLVS are treated as picture boundaries and there is no loop filtering across the subpicture boundaries. sps_independent_subpics_flag equal to 0 does not impose such a constraint. When not present, the value of sps_independent_subpics_flag is inferred to be equal to 1.

sps_subpic_same_size_flag equal to 1 specifies that all subpictures in the CLVS have the same width specified by sps_subpic_width_minus1[0] and the same height specified by sps_subpic_height_minus1[0]. sps_subpic_same_size_flag equal to 0 does not impose such a constraint. When not present, the value of sps_subpic_same_size_flag is inferred to be equal to 0. Let the variable tmpWidthVal be set equal to (sps_pic_width_max_in_luma_samples+CtbSizeY−1)/CtbSizeY, and the variable tmpHeightVal be set equal to (sps_pic_height_max_in_luma_samples+CtbSizeY−1)/CtbSizeY.

sps_subpic_ctu_top_left_x[i] specifies horizontal position of top-left CTU of i-th subpicture in unit of CtbSizeY. The length of the syntax element is Ceil(Log2(tmpWidthVal)) bits. When not present, the value of sps_subpic_ctu_top_left_x[i] is inferred as follows: If sps_subpic_same_size_flag is equal to 0 or i is equal to 0, the value of sps_subpic_ctu_top_left_x[i] is inferred to be equal to 0; Otherwise, the value of sps_subpic_ctu_top_left_x[i] is inferred to be equal to (i % numSubpicCols)*(sps_subpic_width_minus1[0]+1). When sps_subpic_same_size_flag is equal to 1, the variable numSubpicCols, specifying the number of subpicture columns in each picture in the CLVS, is derived as follows: numSubpicCols=tmpWidthVal/(sps_subpic_width_minus1[0]+1). When sps_subpic_same_size_flag is equal to 1, the value of numSubpicCols*tmpHeightVal/(sps_subpic_height_minus1[0]+1)−1 shall be equal to sps_num_subpics_minus1.

sps_subpic_ctu_top_left_y[i] specifies vertical position of top-left CTU of i-th subpicture in unit of CtbSizeY. The length of the syntax element is Ceil(Log2(tmpHeightVal)) bits. When not present, the value of sps_subpic_ctu_top_left_y[i] is inferred as follows: If sps_subpic_same_size_flag is equal to 0 or i is equal to 0, the value of sps_subpic_ctu_top_left_y[i] is inferred to be equal to 0; Otherwise, the value of sps_subpic_ctu_top_left_y[i] is inferred to be equal to (i/numSubpicCols)*(sps_subpic_height_minus1[0]+1).

sps_subpic_width_minus1[i] plus 1 specifies the width of the i-th subpicture in units of CtbSizeY. The length of the syntax element is Ceil(Log2(tmpWidthVal)) bits. When not present, the value of sps_subpic_width_minus1[i] is inferred as follows: If sps_subpic_same_size_flag is equal to 0 or i is equal to 0, the value of sps_subpic_width_minus1[i] is inferred to be equal to tmpWidthVal−sps_subpic_ctu_top_left_x[i]−1; Otherwise, the value of sps_subpic_width_minus1[i] is inferred to be equal to sps_subpic_width_minus1[0]. When sps_subpic_same_size_flag is equal to 1, the value of tmpWidthVal % (sps_subpic_width_minus1[0]+1) shall be equal to 0.

sps_subpic_height_minus1[i] plus 1 specifies the height of the i-th subpicture in units of CtbSizeY. The length of the syntax element is Ceil(Log2(tmpHeightVal)) bits. When not present, the value of sps_subpic_height_minus1[i] is inferred as follows: If sps_subpic_same_size_flag is equal to 0 or i is equal to 0, the value of sps_subpic_height_minus1[i] is inferred to be equal to tmpHeightVal−sps_subpic_ctu_top_left_y[i]−1; Otherwise, the value of sps_subpic_height_minus1[i] is inferred to be equal to sps_subpic_height_minus1[0]. When sps_subpic_same_size_flag is equal to 1, the value of tmpHeightVal % (sps_subpic_height_minus1[0]+1) shall be equal to 0. It is a requirement of bitstream conformance that the shapes of the subpictures shall be such that each subpicture, when decoded, shall have its entire left boundary and entire top boundary consisting of picture boundaries or consisting of boundaries of previously decoded subpictures. For each subpicture with subpicture index i in the range of 0 to sps_num_subpics_minus1, inclusive, it is a requirement of bitstream conformance that all of the following conditions are true: The value of (sps_subpic_ctu_top_left_x[i] *CtbSizeY) shall be less than (sps_pic_width_max_in_luma_samples−sps_conf_win_right_offset*SubWidthC); The value of ((sps_subpic_ctu_top_left_x[i]+sps_subpic_width_minus1[i]+1)*CtbSizeY) shall be greater than (sps_conf_win_left_offset*SubWidthC); The value of (sps_subpic_ctu_top_left_y[i] *CtbSizeY) shall be less than (sps_pic_height_max_in_luma_samples−sps_conf_win_bottom_offset*SubHeightC); and The value of ((sps_subpic_ctu_top_left_y[i]+sps_subpic_height_minus1[i]+1)*CtbSizeY) shall be greater than (sps_conf_win_top_offset*SubHeightC).

sps_subpic_treated_as_pic_flag[i] equal to 1 specifies that the i-th subpicture of each coded picture in the CLVS is treated as a picture in the decoding process excluding in-loop filtering operations. sps_subpic_treated_as_pic_flag[i] equal to 0 specifies that the i-th subpicture of each coded picture in the CLVS is not treated as a picture in the decoding process excluding in-loop filtering operations. When not present, the value of sps_subpic_treated_as_pic_flag[i] is inferred to be equal to 1.

sps_loop_filter_across_subpic_enabled_flag[i] equal to 1 specifies that in-loop filtering operations across subpicture boundaries is enabled and might be performed across the boundaries of the i-th subpicture in each coded picture in the CLVS. sps_loop_filter_across_subpic_enabled_flag[i] equal to 0 specifies that in-loop filtering operations across subpicture boundaries is disabled and are not performed across the boundaries of the i-th subpicture in each coded picture in the CLVS. When not present, the value of sps_loop_filter_across_subpic_enabled_pic_flag[i] is inferred to be equal to 0.

sps_subpic_id_len_minus1 plus 1 specifies the number of bits used to represent the syntax element sps_subpic_id[i], the syntax elements pps_subpic_id[i], when present, and the syntax element sh_subpic_id, when present. The value of sps_subpic_id_len_minus1 shall be in the range of 0 to 15, inclusive. The value of 1<<(sps_subpic_id_len_minus1+1) shall be greater than or equal to sps_num_subpics_minus1+1.

sps_subpic_id_mapping_explicitly_signalled_flag equal to 1 specifies that the subpicture ID mapping is explicitly signalled, either in the SPS or in the PPSs referred to by coded pictures of the CLVS. sps_subpic_id_mapping_explicitly_signalled_flag equal to 0 specifies that the subpicture ID mapping is not explicitly signalled for the CLVS. When not present, the value of sps_subpic_id_mapping_explicitly_signalled_flag is inferred to be equal to 0.

sps_subpic_id_mapping_present_flag equal to 1 specifies that the subpicture ID mapping is signalled in the SPS when sps_subpic_id_mapping_explicitly_signalled_flag is equal to 1. sps_subpic_id_mapping_present_flag equal to 0 specifies that subpicture ID mapping is signalled in the PPSs referred to by coded pictures of the CLVS when sps_subpic_id_mapping_explicitly_signalled_flag is equal to 1.

sps_subpic_id[i] specifies the subpicture ID of the i-th subpicture. The length of the sps_subpic_id[i] syntax element is sps_subpic_id_len_minus1+1 bits.

15. Picture order count (POC)

Pictures in HEVC are identified by their picture order count (POC) values, also known as full POC values. Each slice contains a code word, pic_order_cnt_lsb, that shall be the same for all slices in a picture. pic_order_cnt_lsb is also known as the least significant bits (lsb) of the full POC since it is a fixed-length code word and only the least significant bits of the full POC is signalled. Both encoder and decoder keep track of POC and assign POC values to each picture that is encoded/decoded. The pic_order_cnt_lsb can be signalled by 4-16 bits. There is a variable MaxPicOrderCntLsb used in HEVC which is set to the maximum pic_order_cnt_lsb value plus 1. This means that if 8 bits are used to signal pic_order_cnt_lsb, the maximum value is 255 and MaxPicOrderCntLsb is set to 2\hat{ }8=256. The picture order count value of a picture is called PicOrderCntVal in HEVC. Usually, PicOrderCntVal for the current picture is simply called PicOrderCntVal.

### SUMMARY

Certain challenges presently exist. For instance, in the existing systems for controlling an overlay process (e.g., a film grain, denoising, or renoising process), the overlay process can only be applied per picture, per subpicture, or per slice. For example, in the existing systems, the film grain process can be applied per picture using a film grain characteristics SEI message or can be applied per subpicture using a scalable-nested SEI message containing a film grain characteristics SEI message. This is not adequate for applications that require different overlay handlings, such as noise handling, for areas of the picture that are not matching the subpicture or slice partitions. Examples of such picture areas include: i) rectangular areas that do not coincide with the slice partitioning in the picture; ii) areas in the picture with boundaries that do not coincide with the CTU partitioning or the CU partitioning in the picture; and iii) nonrectangular regions such as other polygon shaped regions, free-form regions, or union of different polygon shaped regions.

Furthermore, in some applications it is desired to apply or avoid applying an overlay process such as a film grain process to an area of the picture with a particular content or color value. Some examples for this scenario are: i) areas with specific statistical properties or color for the content such as grass, sky or flat texture surfaces; ii) areas that are different in their importance, sensitivity or interest such as a human face; and iii) mix of natural and computer graphics content such as an animated figure on a natural background, a score board during sports, subtitles or text over natural background, etc.

In all the above scenarios it is desired to be able to define and control an overlay process for an area of the picture which is not bound to follow the slice boundaries. This is not currently possible using existing solutions in AVC, HEVC or VVC.

Yet another problem with using a scalable-nested SEI message containing a film grain characteristics SEI message is that all subpictures to which the film grain process is applied must be explicitly defined and signalled. If the film grain process is going to be applied to all the picture except one single subpicture A in the picture, the signalling needs to include all the subpictures except subpicture A which may not be a bit-efficient signalling. Some other limitations regarding the scalable nesting SEI message solution in VVC version 1 are: i) the number of scalable-nested SEI messages in a scalable nesting SEI is limited to a maximum of 64 and ii) more than one scalable nesting SEI message is required to specify more than one scalable nested film grain SEI messages applied to different subpicture sets in a picture. Additionally, when the scalable-nested SEI message is used to apply an SEI message to a subpicture area, it uses the subpicture ID to define the subpicture area, but the subpicture information describing the subpicture layout may not always be present in a post-processing step decoupled from the decoder. A post-processing step may for instance only take the decoded picture and information from SEI messages as input.

Accordingly, in one aspect there is provided a method for applying an overlay process to a picture in a bitstream. In one embodiment the method includes decoding a first set of one or more overlay process parameters from syntax elements in the bitstream, the first set of one or more overlay process parameters specifying a first overlay process. The method also includes decoding a first set of one or more picture partitioning parameters from syntax elements in the bitstream, the first set of one or more picture partitioning parameters specifying a first segment area of the picture, wherein a boundary of the first segment area of the picture is not fully aligned with a boundary of the picture or a boundary of any subpictures of the picture or a boundary of any slices in the picture. The method further includes decoding the picture, wherein decoding the picture comprises applying the first overlay process on the first segment area of the picture using the first set of one or more overlay process parameters.

In another aspect there is proved a method performed by an encoder. In one embodiment, the method includes obtaining a first set of one or more overlay process parameters, the first set of one or more overlay process parameters specifying a first overlay process. The method also includes obtaining a first set of one or more picture partitioning parameters, the first set of one or more picture partitioning parameters specifying a first segment area of a picture, wherein a boundary of the first segment area of the picture is not fully aligned with a boundary of the picture or a boundary of any subpictures of the picture or a boundary of any slices in the picture. The method further includes generating a bitstream, wherein the bitstream comprises a first set of one or more syntax elements encoding the first set of one or more overlay process parameters and a second set of one or more syntax elements encoding the first set of one or more picture partitioning parameters.

In another aspect there is provided a computer program comprising instructions which when executed by processing circuitry of an apparatus causes the apparatus to perform any of the methods disclosed herein. In one embodiment, there is provided a carrier containing the computer program wherein the carrier is one of an electronic signal, an optical signal, a radio signal, and a computer readable storage medium. In another aspect there is provided an apparatus that is configured to perform the methods disclosed herein. The apparatus may include memory and processing circuitry coupled to the memory.

An advantage of the embodiments disclosed herein is that they enable overlay processes to be defined and applied independent from the knowledge of the slice and subpicture partitioning in the picture. The segment area to which the overlay process is applied may, therefore, be defined in a more flexible way in contrast to the scalable nesting SEI in VVC where the finest granularity to define segment area is a subpicture granularity.

Another advantage of the embodiments is that the overlay process can be applied to a segment area in the picture without the need to access the NAL units that describe the picture partitioning. For instance, if the overlay process is defined in an SEI message, there is no need to access the SPS in VVC where the subpicture partitioning structure is defined or the PPS in VVC where the slice partitioning structure is defined, and it is known from the SEI message to which part of the picture to apply the overlay process. The embodiments also remove the need to consider subpicture partitioning in defining the overlay process area when sub-bitstreams are merged to create one bitstream which simplifies the bit stream merging process.

Another advantage of the embodiments is that the content creator is given greater flexibility in defining and applying overlay processes, such as, for example, a film grain process, a denoising process, a renoising process, or other overlay processes, to the decoded picture or video. As a result, the overlay process will not be limited to subpicture or slice partitions and can be defined and applied to or stopped from being applied to a desired area of the picture that does not necessarily match the slice or subpicture partitioning. Examples of such areas include: 1) rectangular areas that do not coincide with the slice partitioning in the picture; 2) areas in the picture with boundaries that do not coincide with the CTU partitioning or the CU partitioning in the picture; 3) nonrectangular regions such as other polygon shaped regions or a union of different polygon shaped regions; and 4) an area of the picture with a particular content or color value, such as, for example: i) areas with specific statistical properties of the luminance or color samples such as grass, sky, water or flat texture surfaces, ii) areas that are different in their importance, sensitivity or interest such as a human face, and iii) a mix of captured content and computer graphics content such as an animated figure in a natural background, a score board during sports, text over natural background, etc.

Another advantage of the embodiments is that the overlay process can be defined to be applied to all the picture except a defined area. If the overlay process is going to be applied to all the picture except one single area defined as A, it can be more efficient to signal the area A and not all the other parts of the picture depending on the partitioning of the picture into segment areas.

Another benefit of the embodiments, compared to the existing solution of the scalable nested SEI message where an SEI message can be signalled for subpictures using the subpicture ID, is that there is no need for the parser of the SEI message to be aware of the subpictures and their subpicture IDs. This is useful for when the overlay process parameters of the SEI message are used in a post-process operation detached from the decoding of the video.

### BRIEF DESCRIPTION OF THE DRAWINGS

The accompanying drawings, which are incorporated herein and form part of the specification, illustrate various embodiments.

FIG. TA illustrates the relation between layer access units and coded layer video sequences.

FIG. 1B shows an example of a tile partitioning.

FIG. 1C shows another example of a tile partitioning.

FIG. 1D shows an example of rectangular slice partitioning.

FIG. 2 illustrates a system according to an embodiment.

FIG. 3 is a schematic block diagram of an encoder according to an embodiment.

FIG. 4 is a schematic block diagram of a decoder according to an embodiment.

FIG. 5 illustrates a system according to an embodiment.

FIG. 6A illustrates a picture that is partitioned into two rectangular segment areas.

FIG. 6B illustrates a picture that is partitioned into two segment areas and one of the segment areas is not rectangular.

FIG. 6C illustrates a mask that partitions a picture into two segment areas.

FIGS. 6D-6G illustrate various examples of a picture being partitioned into two segment areas where one of the segment areas consists of two sub-segment areas.

FIG. 7 is a flowchart illustrating a process according to an embodiment.

FIG. 8 is a flowchart illustrating a process according to an embodiment.

FIG. 9 is a block diagram of an apparatus according to an embodiment.

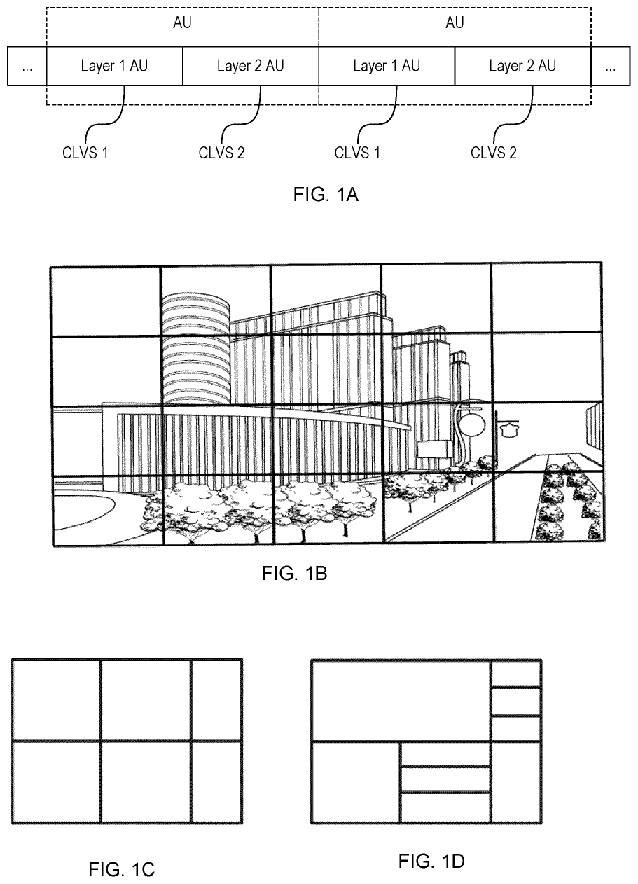

### DETAILED DESCRIPTION

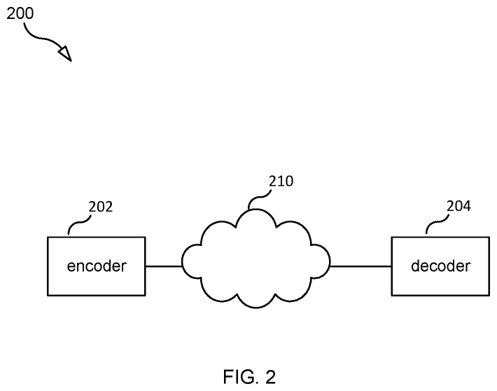

FIG. 2 illustrates a system 200 according to an example embodiment. System 200 includes an encoder 202 in communication with a decoder 204 via a network 210 (e.g., the Internet or other network).

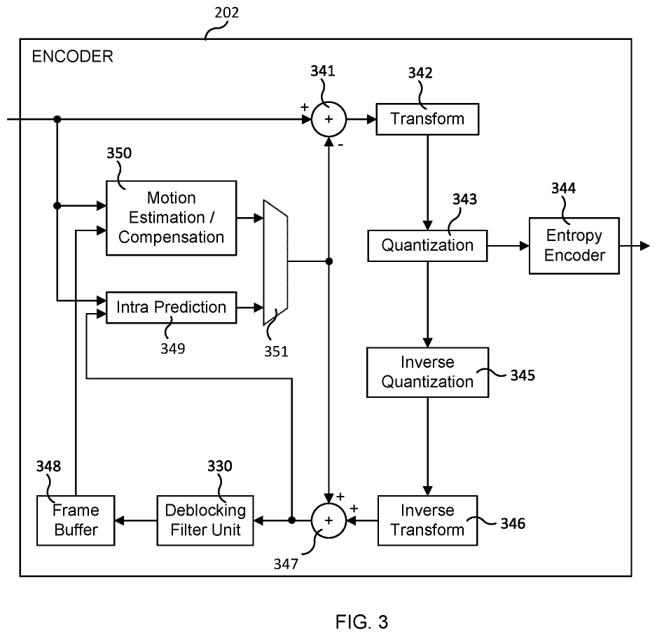

FIG. 3 is a schematic block diagram of encoder 202 for encoding a block of pixel values (hereafter “block”) in a video frame (picture) of a video sequence according to an embodiment. A current block is predicted by performing a motion estimation by a motion estimator 350 from an already provided block in the same frame or in a previous frame. The result of the motion estimation is a motion or displacement vector associated with the reference block, in the case of inter prediction. The motion vector is utilized by a motion compensator 350 for outputting an inter prediction of the block. An intra predictor 349 computes an intra prediction of the current block. The outputs from the motion estimator/compensator 350 and the intra predictor 349 are input in a selector 351 that either selects intra prediction or inter prediction for the current block. The output from the selector 351 is input to an error calculator in the form of an adder 341 that also receives the pixel values of the current block. The adder 341 calculates and outputs a residual error as the difference in pixel values between the block and its prediction. The error is transformed in a transformer 342, such as by a discrete cosine transform, and quantized by a quantizer 343 followed by coding in an encoder 344, such as by entropy encoder. In inter coding, also the estimated motion vector is brought to the encoder 344 for generating the coded representation of the current block. The transformed and quantized residual error for the current block is also provided to an inverse quantizer 345 and inverse transformer 346 to retrieve the original residual error. This error is added by an adder 347 to the block prediction output from the motion compensator 350 or the intra predictor 349 to create a reference block that can be used in the prediction and coding of a next block. This new reference block is first processed by a deblocking filter unit 330 according to the embodiments in order to perform deblocking filtering to combat any blocking artifact. The processed new reference block is then temporarily stored in a frame buffer 348, where it is available to the intra predictor 349 and the motion estimator/compensator 350.

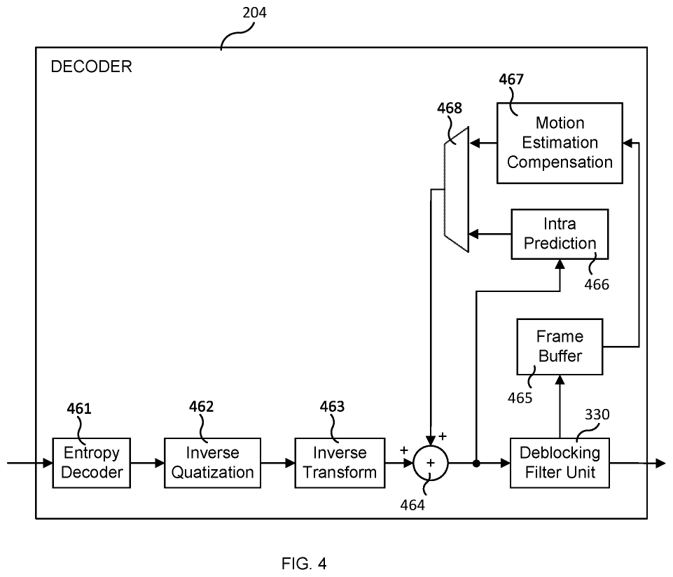

FIG. 4 is a corresponding schematic block diagram of decoder 404 according to some embodiments. The decoder 404 comprises a decoder 461, such as entropy decoder, for decoding an encoded representation of a block to get a set of one or more quantized and transformed residual errors. These residual errors are dequantized in an inverse quantizer 462 and inverse transformed by an inverse transformer 463 to get a set of one or more residual errors. These residual errors are added in an adder 464 to the pixel values of a reference block. The reference block is determined by a motion estimator/compensator 467 or intra predictor 466, depending on whether inter or intra prediction is performed. A selector 468 is thereby interconnected to the adder 464 and the motion estimator/compensator 467 and the intra predictor 466. The resulting decoded block output form the adder 464 is input to a deblocking filter unit 330 according to the embodiments in order to deblocking filter any blocking artifacts. The filtered block is output form the decoder 404 and is furthermore preferably temporarily provided to a frame buffer 465 and can be used as a reference block for a subsequent block to be decoded. The frame buffer 465 is thereby connected to the motion estimator/compensator 467 to make the stored blocks of pixels available to the motion estimator/compensator 467. The output from the adder 464 is preferably also input to the intra predictor 466 to be used as an unfiltered reference block.

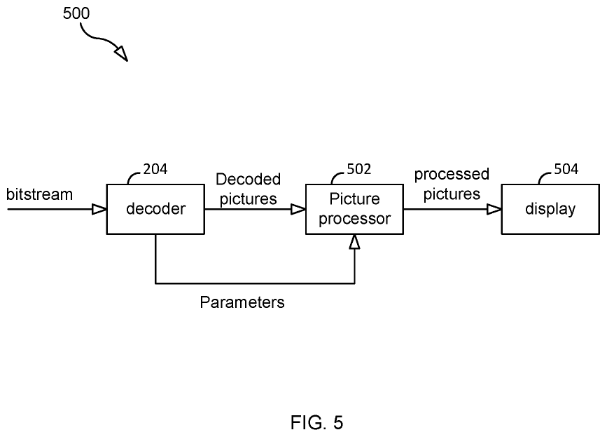

FIG. 5 illustrates a user equipment (UE) 500 according to an embodiment. As shown in FIG. 5, UE 500 includes decoder 204, which receives a bitstream (e.g., a bitstream generated by encoder 202) and, based on the information in the bitstream, generates decoded pictures. UE 500 also includes a picture processor 502 which may process one or more of the decoded pictures using parameters provided by decoder 204 to produce processed pictures, which may be displayed on a display 504 of UE 500 (e.g., picture process 502 may perform an overlay process). While picture processor 502 is illustrated in FIG. 5 as being separate from decoder 204, this is not a requirement as in some embodiments picture processor 502 may be a component of decoder 204. Picture processor 502 may produce a processed picture that is a modified version of a decoded picture in a number of different ways, such as one of the following or a combination of two or more of the following:
1. Apply film grain
2. Apply a color transform and/or color component value scaling
3. Apply a projection mapping or inverse projection mapping such as converting the decoded picture from a cube map projection to a spherical representation or to an equirectangular representation.
4. Perform a region-wise packing or region-wise unpacking of the picture by a set of one or more region-wise operations such as repositioning, scaling and rotation
5. Crop the decoded picture
6. Convert the decoded picture to a different color format such as from Rec 709 to PQ
7. Convery the decoded picture to a different chroma format such as from YUV 4:2:0 to YUV 4:4:4
8. Scale or resample the picture from a decoded resolution to an output resolution
9. Convert to a different sample aspect ratio
10. Convert two decoded fields to an interlaced picture
11. Apply/remove frame packing
12. Extracting one or more subpictures (similar to cropping the decoded picture but may for instance comprise merging subpictures from different locations in the picture.
   Adding Noise or Film Grain after Decoding Pictures

Noise in video originates from different sources. This noise can be suppressed by the encoder at the earliest stage of the process. When the picture is reconstructed at the decoder before display, modelled or unmodeled noise can be added to the decoded picture. Different objectives have been introduced that manifests the subjective quality increase by adding noise which, as a result of increase in picture resolution, has now become more apparent. The first reason to add noise might be to introduce artistic effects, e.g. while shooting documentaries, portraits, black and white scenes, to capture reality, or to get the “real cinema effect” for movies. The second reason is to hide coding artifacts such as blurriness, blocking, and banding effects appeared due to the heavy encoding procedure in the encoder.

### Film Grain

### Film Grain Characteristics SEI Message in VVC

A film grain process is supported in VVC. This process is essentially identical to the film grain processes specified in the H.264/AVC and HEVC video coding standards. The process includes an SEI message that carries a parametrized model for film grain synthesis in the decoder. The film grain characteristic SEI message includes a cancel flag, film_grain_characteristics_cancel_flag, which enables the film grain process if it is set equal to 0. Also, when the flag is set to 0, film grain parameter syntax elements follow the flag. At last, film_grain_characteristics_persistence_flag specifies the persistence of the film grain characteristic SEI message for the current layer. In Table 10 below, a simplified version of the syntax is shown.

TABLE 10
Film grain characteristics SEI message syntax in VVC

| | Type |
|---|---|
| film_grain_characteristics(payloadSize) { | |
| film_grain_characteristics_cancel_flag | u(1) |
| if ( !film_grain_characteristics_cancel_flag ) { | |
| film_grain_mode_id | u(2) |
| separate_colour_description_present_flag | u(1) |
| if (separate_colour_description_present_flag) { | |
| color_specific_parameters( ) | |
| } | |
| more_film_grain_parameters( ) | |
| film_grain_characteristics_persistence_flag | u(1) |
| } | |

### Film Grain in SMPTE RDD 5 (2006)

In the Film Grain Technology—specification introduced in [SPMTE], a seed derivation method is specified that derives a seed value to be used for the Film grain characteristics SEI process. The seed is initialized using information that is already available at the decoder and is selected from a predetermined set of one or more 256 possible seeds in a look-up table. For the pseudo-random number generator, and to select 8×8 blocks of samples, the seed is initialized as: seed=Seed_LUT[Mod[pic_offset+color_offset[c], 256)], in which color_offset[c] is equal to 0, 85, and 170 for Y, Cb and Cr channels respectively and pic_offset is defined as: pic_offset=POC(curr_pic)+(POC_offset<<5), where POC(curr_pic) is equal to the picture order count value of the current frame; and POC_offset is set equal to the value of idr_pic_id on IDR frames, otherwise it is set equal to 0. Moreover, the pseudo-random number generator for creation of 64×64 sample blocks is initialized as follows: seed=Seed LUT[h+v*13], where h and v represent a value for horizontal and vertical directions respectively. Both h and v are in the range of [0,12] and determine which pattern of the film grain database is used as source of film grain samples. Finally, in either cases, the output of Seed_LUT[.], which is the variable of the variable seed above, is used as the seed for the pseudo-random number generator.

### Film Grain in AV1

The AV1 video codec format supports film grain generation. The film grain is applied when a picture is output. The sequence_header_obu( ) contains a film_grain_params_present_flag that is an enable flag for the film grain signalling and process. The film grain parameters are signalled last in the frame_header_obu( ) in a syntax table called film_grain_params( ) which is shown in Table 11 below.

TABLE 11
Film grain parameters syntax in AV1

| | Type |
|---|---|
| film_grain_params( ) { | |
| if ( !film_grain_params present \| (!show_frame && !showable_frame) ) { | |
| reset_grain_params( ) | |
| Return | |
| } | |
| apply_grain | f(1) |
| if ( !apply_grain ) { | |
| reset_grain_params( ) | |
| Return | |
| } | |
| grain_seed | f(16) |
| if ( frame_type == INTER FRAME ) | |
| update_grain | f(1) |
| Else | |
| update_grain = 1 | |
| if ( !update_grain ) { | |
| film_grain_params_ref_idx | f(3) |
| tempGrainSeed = grain_seed | |
| load_grain_params( film_grain_params_ref_idx ) | |
| grain_seed = tempGrainSeed | |
| Return | |
| } | |
| more_film grain_parameters( ) | |
| } | |

In film_grain_params( ) first there is a flag, apply_grain, that controls whether film grain shall be applied to the current picture or not. Then there is a 16-bit grain_seed syntax element that is used as a seed for a pseudo-random number generator that generates the grains. The update_grain flag specifies whether film grain parameter values from a reference picture should be used, or if the film grain parameter values to use shall be decoded from the frame header. The reference picture to use is identified by the film_grain_params_ref_idx syntax element value. In Table 11, the frame header film grain parameters are represented by the more_film_srain_parameters( ) row to simplify the table. The value of grain_seed initializes the seed for the pseudo-random number generator used for the Luma component of the white noise grain. For chroma components Cb and Cr, the value is modified via XOR operation as follows: Cb_seed=grain_seed\hat{ }0xb524 and Cr_seed=grain_seed\hat{ }0x49d8.

### Scalable Nesting SEI Message

The scalable nesting SEI message in VVC provides a mechanism to associate SEI messages with specific OLSs, specific layers, or specific sets of subpictures. A scalable nesting SEI message contains one or more SEI messages. The SEI messages contained in the scalable nesting SEI message are also referred to as the scalable-nested SEI messages. The scalable nesting SEI message syntax in VVC is shown in Table 12.

TABLE 12
Scalable nesting SEI message syntax in VVC

| | Descriptor |
|---|---|
| scalable_nesting( payloadSize ) { | |
| sn_ols_flag | u(1) |
| sn_subpic_flag | u(1) |
| if( sn_ols_flag ) { | |
| sn_num_olss_minus1 | ue(v) |
| for( i = 0; i <= sn_num_olss_minus1; i++ ) | |
| sn_ols_idx_delta_minus1 [ i ] | ue(v) |
| } else { | |
| sn_all_layers_flag | u(1) |
| if( !sn_all_layers_flag ) { | |
| sn_num_layers_minus1 | ue(v) |
| for( i = 1; i <= sn_num_layers_minus1; i++) | |
| sn_layer_id[ i ] | u(6) |
| } | |
| } | |
| if( sn_subpic_flag ) { | |
| sn_num_subpics_minus1 | ue(v) |
| sn_subpic_id_len_minus1 | ue(v) |
| for( i = 0; i <= sn_num_subpics_minus1; i++ ) | |
| sn_subpic_id[ i] | u(v) |
| } | |
| sn_num_seis_minus1 | ue(v) |
| while( !byte_aligned( ) ) | |
| sn_zero_bit /* equal to 0 */ | u(1) |
| for( i = 0; i <= sn num_seis_minus1; i++ ) | |
| sei_message( ) | |
| } | |

A similar scalable nesting SEI message also exists in HEVC. The HEVC scalable nesting SEI message is providing a mechanism to associate SEI messages with bitstream subsets corresponding to various operation points or with specific layers or sublayers. The subpicture concept does not exist in HEVC and so the nesting SEI message in HEVC could not be used to associate SEI messages with specific sets of subpictures in contrast to VVC nesting SEI message, The scalable nesting SEI message syntax in HEVC is shown in Table 13.

TABLE 13
Scalable nesting SEI message syntax in HEVC

| | Descriptor |
|---|---|
| scalable_nesting( payloadSize ) { | |
| bitstream_subset_flag | u(1) |
| nesting_op_flag | u(1) |
| if( nesting_op_flag ) { | |
| default_op_flag | u(1) |
| nesting_num_ops_minus1 | ue(v) |
| for( i = default_op_flag; i <= nesting_num_ops_minus1; i++ ) { | |
| nesting_max_temporal_id_plus1 [ i ] | u(3) |
| nesting_op_idx[ i ] | ue(v) |
| } | |
| } else { | |
| all_layers_flag | u(1) |
| if( !all_layers_flag ) { | |
| nesting_no_op_max_temporal_id_plus1 | u(3) |
| nesting_num_layers_minus1 | ue(v) |
| for( i = 0; i <= nesting_num_layers_minus1; i++ ) | |
| nesting_layer_id[ i ] | u(6) |
| } | |
| } | |
| while( !byte_aligned( ) ) | |
| nesting_zero_bit /* equal to 0 */ | u(1) |
| Do | |
| sei_message( ) | |
| while( more_rbsp_data( ) ) | |
| } | |

In the description below, various embodiments are described that solve one or more of the above described problems. It is to be understood by a person skilled in the art that two or more embodiments, or parts of embodiments, may be combined to form new embodiments which are still covered by this disclosure.

The following terminology is used herein:

Segment area: A segment area is a part of a picture. A picture may be partitioned into multiple segment areas. Not all boundaries of a segment area are aligned with the picture or subpicture or slice boundaries. A segment area may for instance be, a tile, a CTU, a CU, a PU or part of a picture, part of a subpicture, part of a slice, part of a tile, part of a CTU, part of a CU or part of a PU.

Sub-segment area: A sub-segment area is a part of a segment area. A segment area may be divided into multiple sub-segment areas. A sub-segment area may for instance be a subpicture, a slice, a tile, a CTU, a CU, a PU or part of a picture, part of a subpicture, part of a slice, part of a tile, part of a CTU, part of a CU or part of a PU.

Overlay process: An overlay process is a process which takes a pixel value and overlay process parameters as inputs and generates or outputs a final pixel value based on the inputs. One example of an overlay process is when the final pixel values is obtained by adding an overlay value to the initial pixel value where the overlay value is obtained from the overlay process parameters. The overlay process may be applied on sample values or decoded pixel values in the decoding process or in a post-processing step either after the segment area has been decoded but before the decoded picture is output from the decoder, or after the decoded picture is output but before the decoded picture is displayed. An example of the overlay process is a film grain process. Typically, the film grain pattern has been estimated from the original pixel values in the segment area before encoding, but it could also be estimated in other ways. Another example of an overlay process is a renoising process. A renoising process may add noise to decoded pixel values in a segment area where the original noise pattern is unknown, in order to mask coding artifacts. An overlay process need not be a pure function of the initial pixel value but may take both the initial pixel value and the overlay process parameters as input and outputs the final pixel value. The overlay process is denoted as O( ) in the following illustration: final_pixel_value=O(initial_pixel_value, overlay_process_parameters).

In one example, the overlay process is defined as a film grain process and the final pixel value is determined as the sum of the initial pixel value and a film grain value where the film grain value is output of F( ) that takes the film grain parameters as input:

$$final\_pixel \_value = O ( initial\_pixel \_value , film\_grain \_parameters ) = initial\_pixel \_value + F ( film\_grain \_parameters ) = initial\_pixel \_value + film\_grain \_value .$$

Overlay process parameters: An overlay process parameter is a parameter related to an overlay process, such as type of the model or overlay filter used in the overlay process, strength of the model or filter, seed to pseudo-randomize patterns or other values for generating pattern for the overlay process such as the seed for film grain pattern in the film grain process. Parameters related to one overlay process may be referred to as a set of one or more overlay parameters.

Overlay value: An overlay value is a value obtained from the overlay process parameters. This value may be used for creating the final pixel value as the output of the overlay process.

Overlay process area: An overlay process area is a segment area of a picture to which an overlay process is applied.

### Embodiment 1—Signalling a Segment Area with Boundaries not Fully Aligned with Picture, Subpicture, or Slice Boundaries, Signalling Overlay Process Parameters, and Applying an Overlay Process to the Segment Area

In this embodiment, a segment area and an overlay process are specified where the boundaries of the segment area are not fully aligned with the boundaries of the picture or boundaries of existing subpictures or slices in the picture. That is, a segment area may have a shape and/or position not possible to produce with a subpicture partitioning and slice partitioning scheme. The picture is then decoded where decoding the picture comprises applying the overlay process only on the segment area of the picture. The overlay process may be applied using a set of one or more overlay process parameters signalled in the bitstream, e.g. in an SEI message, a parameter set such as APS, PPS, SPS or VPS, in a picture header or in a slice header.

When the boundaries of the segment area are not fully aligned with the boundaries of the picture or boundaries of existing subpictures or slices in the picture, there exists at least a part of the boundaries of the segment area which is not part of the picture boundaries and is not part of the boundaries of existing subpictures or slices in the picture. In other words, if one drew all boundaries of a picture, all boundaries of slices in the picture, and all boundaries of subpictures in the picture, one would see a difference (e.g., a new boundary line segment that does not coincide with any of the other boundary line segments) when the boundaries of the segment area are drawn.

A segment area of a picture may be specified by means of geometrical partitioning (i.e., the geometry or shape of the segment area is specified (explicitly or implicitly)). In one example, the geometrical partitioning is specified explicitly for the segment area that the overlay process is applied to. In another example, the geometrical partitioning of the segment area may be specified indirectly, for example, by specifying a segment area and specifying that the segment area that the overlay process is applied to is derived as the area of the picture which is not part of the segment area. The segment area may be a rectangular area. The segment area SA may have other shapes or be the union of two or more connected or unconnected areas in the picture.

In one embodiment, an indicator value is used to determine whether the overlay process using a set of one or more overlay process parameters is applied on a segment area of the picture or not. The indicator value may for instance be a flag or a value in a certain range such as an index. The indicator value may be signalled in a syntax element in the bitstream, e.g. in a CU, CTU, slice header, picture header or parameter set such as APS, PPS, SPS or VPS or from an SEI message. If the indicator value has a certain value, e.g. 1, then the overlay process is applied on the segment area using the set of one or more overlay process parameters. If the indicator value has another value, e.g. 0, then the overlay process is not applied on the segment area using the set of one or more overlay process parameters.

In one embodiment, there is one indicator value for each segment area of a picture. In another embodiment, an indicator value is used to determine whether the overlay process using a set of one or more overlay process parameters is applied to one or more segment areas of a picture.

In another embodiment, the indicator value may also be used to determine whether the overlay process parameters are to be decoded from the bitstream or not.

In one embodiment, a decoder may perform all or a subset of the following steps for decoding a picture from a bitstream and applying an overlay:
1. Decoding a first set of one or more overlay process parameters from syntax elements in the bitstream, the overlay process parameters specifying an overlay process;
2. Decoding a first set of one or more picture partitioning parameters from syntax elements in the bitstream, the first set of one or more picture partitioning parameters specifying a first segment area of the picture, wherein the boundaries of the first segment area are not fully aligned with the boundaries of the picture or boundaries of subpictures or boundaries of slices in the picture;
3. Decoding a first indicator value from a first syntax element in the bitstream. Only apply the overlay process on the first segment area of the picture using the first set of one or more overlay process parameters in step 5 below if the first indicator value has a certain value, e.g. 1;
4. Decoding a second set of one or more overlay process parameters from syntax elements in the bitstream and decoding a second indicator value from a second syntax element in the bitstream. If the second indicator value has a certain value, e.g. 1, the decoding of the picture in step 5 further comprises applying the overlay process to a second segment area of the picture using the second set of one or more overlay process parameters. If the second indicator value has another value, e.g. 0, the decoding of the picture in step 5 does not comprise applying the overlay process to a second segment area of the picture using the second set of one or more overlay process parameters; and
5. Decoding the picture where decoding the picture comprises applying the overlay process on the first segment area of the picture using the first set of one or more overlay process parameters.

In another embodiment the decoder may perform all or a subset of the following steps for decoding a picture from a bitstream and applying an overlay:
1. Decoding a first set of one or more overlay process parameters from syntax elements in the bitstream, the first set of one or more overlay process parameters specifying a first overlay process;
2. Decoding picture partitioning parameters from syntax elements in the bitstream, the picture partitioning parameters specifying at least a first segment area of the picture and a second segment area of the picture;
3. Decoding the first segment area of the picture from the bitstream using the first set of one or more overlay process parameters wherein the boundaries of the first segment area are not fully aligned with the boundaries of the picture or boundaries of subpictures or boundaries of slices in the picture; and
4. Decoding the second segment area of the picture from the bitstream without using the first set of one or more overlay process parameters.

In another embodiment the decoder may perform all or a subset of the following steps:
1. Decoding picture partitioning parameters from syntax elements in the bitstream, the picture partitioning parameters specifying at least a first segment area of the picture and a second segment area of the picture;
2. Decoding a first set of one or more overlay process parameters;
3. Decoding a first codeword from a first syntax element in the bitstream;
4. Decoding a second codeword from a second syntax element in the bitstream;
5. In response to the first codeword having a first value, decoding the first segment area of the picture from the bitstream using the first set of one or more overlay process parameters; and
6. In response to the second codeword having a second value, decoding the second segment area of the picture from the bitstream not using the first set of one or more overlay process parameters.

In some embodiments, the first codeword is the same as the second codeword.

An encoder may perform all or a subset of the following steps:
1. Specifying an overlay process by specifying a first set of one or more overlay process parameters for the picture;
2. Specifying picture partitioning parameters for partitioning the picture into one or more segment areas including a first segment area where the first segment area is the segment area that the overlay process is applied to, wherein the boundaries of the first segment area are not fully aligned with the boundaries of the picture or the boundaries of subpictures or the boundaries of slices in the picture; and
3. Encoding the picture partitioning parameters and the first set of one or more overlay process parameters into the bitstream.

### Embodiment 2—Defining a Segment Area and Overlay Process Parameters in One NAL Unit

In this embodiment syntax elements for the partitioning of the picture into segment areas and the overlay process parameters are signalled in one non-VCL NAL unit such as an SEI message. That is, picture partitioning parameters and overlay process parameters are contained in one non-VCL NAL unit.

In one example of this embodiment the picture partitioning parameters that are included in the NAL unit only explicitly specify the overlay process area(s) (i.e., the area(s) of the picture that no overlay process is applied to is not explicitly signalled), and the NAL unit also includes the overlay process parameters.

An example of syntax and semantics for this embodiment is shown below:

| | Descriptor |
|---|---|
| overlay_process_sei( payloadSize ) { | |
| ops_num_overlay_process_areas | u(n) |
| for (i = 0; i < ops_num_overlay_process_areas) | |
| ops_overlay_process_area_x_pos[ i ] | u(n) |
| ops_overlay_process_area_y_pos[ i ] | u(n) |
| ops_overlay_process_area_width[ i ] | u(n) |
| ops_overlay_process_area_height[ i ] | u(n) |
| } | |
| overlay_process_parameters( ) | |
| } | |

ops_num_overlay_process_areas specifies the number of overlay process areas for which to apply the overlay process specified by the overlay process parameters in overlay_process_parameters( ).
ops_overlay_process_area_x_pos[i] specifies the x-position of the overlay process area with index i.
ops_overlay_process_area_y_pos[i] specifies the y-position of the overlay process area with index i.
ops_overlay_process_area_width[i] specifies the width of the overlay process area with index i.
ops_overlay_process_area_height[i] specifies the height of the overlay process area with index i.
overlay_process_parameters( ) specifies values for the process parameters used to apply the overlay process on the overlay process areas.

In one embodiment, there may be only one overlay process and one overlay process area in one non-VCL NAL unit applied to one picture.

A decoder may perform all or a subset of the following steps according to this embodiment:
1. Decoding a first set of one or more overlay process parameters from syntax elements in a first NAL unit in the bitstream, the overlay process parameters specifying an overlay process;
2. Decoding picture partitioning parameters from syntax elements in the first NAL unit in the bitstream, the picture partitioning parameters specifying a first segment area, wherein the first segment area is the segment area that the overlay process is applied to; and the boundaries of the first segment area are not fully aligned with the boundaries of the picture or boundaries of subpictures or boundaries of slices in the picture; and
3. Decoding the picture where decoding the picture comprises applying the overlay process on the first segment area of the picture using the first set of one or more overlay process parameters.

An encoder may perform all or a subset of the following steps according to this embodiment:
1. Specifying an overlay process by specifying a first set of one or more overlay process parameters for the picture;
2. Specifying picture partitioning parameters for partitioning the picture into one or more segment areas including a first segment area, where the first segment area is the segment area that the overlay process is applied to, wherein the boundaries of the first segment area are not fully aligned with the boundaries of the picture or the boundaries of subpictures or boundaries of slices in the picture; and
3. Encoding the picture partitioning and the first set of one or more overlay process parameters into a first non-VCL NAL unit in the bitstream.

In another example of this embodiment, a NAL unit for one picture may contain i) overlay process parameters that specify more than one overlay process and ii) picture partitioning parameters that specify more than one overlay process area.

### Embodiment 3—Defining a Segment Area and the Overlay Process Model in a Parameter Set

In this embodiment syntax elements for the partitioning of the picture to segment areas and the overlay process are signalled in a header (such as a picture header (PH) or a slice header (SH)) or in a parameter set (such as a sequence parameter set (SPS), a picture parameter set (PPS), an adaptive parameter set (APS)).

A decoder may perform all or a subset of the following steps according to this embodiment:
1. Decoding a first set of one or more overlay process parameters from syntax elements in a first header or parameter set in the bitstream, the overlay process parameters specifying an overlay process; and
2. Decoding picture partitioning parameters from syntax elements in a second header or parameter set in the bitstream, the picture partitioning parameters specifying at least a first segment area, wherein the first segment area is the segment area that the overlay process is applied to and the boundaries of the first segment area are not fully aligned with the boundaries of the picture or boundaries of subpictures or boundaries of slices in the picture; and
3. Decoding the picture where decoding the picture comprises applying the overlay process on the first segment area of the picture using the first set of one or more overlay process parameters.

An encoder may perform all or a subset of the following steps according to this embodiment:
1. Specifying an overlay process by specifying a first set of one or more overlay process parameters for the picture;
2. Specifying picture partitioning parameters that specify at least a first segment area, where the first segment area is the segment area that the overlay process is applied to, wherein the boundaries of the first segment area are not fully aligned with the boundaries of the picture or the boundaries of subpictures or the boundaries of slices in the picture;
3. Encoding the picture partitioning parameters into a first header or parameter set in the bitstream; and
4. Encoding the first set of one or more overlay process parameters into a second header or parameter set in the bitstream.

In a variant of this embodiment the first header or parameter set is the same as the second header or parameter set.

### Embodiment 4—Defining an Overlay Process Area in a Parameter Set or an SEI Message and Using the Overlay Process Model that is Signalled in a Film Grain SEI Message

In this embodiment the overlay process area is specified in a header or parameter set (such as a picture header (PH), a slice header (SH), a sequence parameter set (SPS), a picture parameter set (PPS), or an adaptive parameter set (APS)) and the overlay process parameters are decoded from a separate NAL unit such as an SEI message. Partitioning of the picture into segment areas may be signalled in the same NAL unit where the overlay process area is signalled or in a separate NAL unit.

Exemplary decoder steps according to this embodiment are given here. A decoder may perform all or a subset of the following steps according to this embodiment:
1—Decoding picture partitioning parameters from a first NAL unit in the bitstream, where the parameters specify a first segment area and where the boundaries of a first segment area is not fully aligned with the picture boundaries or subpicture boundaries or slice boundaries;
2—Decoding a first set of one or more overlay process parameters from a second NAL unit in the bitstream
3—Decoding a first syntax element from a third NAL unit in the bitstream. Do step 4 in response to the first syntax element being equal to a first value.
4—Decoding the first segment area of the picture from the bitstream using the first set of one or more overlay process parameters.

In a variant of this embodiment, the first NAL unit and the third NAL unit are the same NAL unit.

In another variant of this embodiment, the second NAL unit and the third NAL unit are the same NAL unit.

An encoder may perform all or a subset of the following steps according to this embodiment:
1. Specifying picture partitioning parameters that specify at least a first segment area where the first segment area is the segment area that the overlay process is applied to, wherein the boundaries of the first segment area are not fully aligned with the boundaries of the picture or the boundaries of subpictures or boundaries of slices in the picture; 2. Specifying an overlay process by specifying a first set of one or more overlay process
parameters for the picture;
3. Encoding the picture partitioning into a first NAL unit in the bitstream;
4. Encoding a first syntax element into a third NAL unit in the bitstream, do step 5 in response to the first syntax element being equal to a first value; and
5. Encoding the first set of one or more overlay process parameters into a second NAL unit in the bitstream.

In a variant of this embodiment, the first NAL unit and the third NAL unit are the same NAL unit.

In another variant of this embodiment, the second NAL unit and the third NAL unit are the same NAL unit.

### Embodiment 5—Using Multiple Overlay Process Models in One Picture

In this embodiment two or more overlay processes are defined and applied to overlay process area(s) in the picture. Multiple overlay processes may be defined in one NAL unit such as one SEI message or in more than one NAL units such as multiple SEI messages.

A decoder may perform all or a subset of the following steps according to this embodiment:
1. Decoding a first set of one or more overlay process parameters from a first set of one or more syntax elements in the bitstream, the first set of one or more overlay process parameters specifying a first overlay process;
2. Decoding a second set of one or more overlay process parameters from a second set of one or more syntax elements in the bitstream, the second set of one or more overlay process parameters specifying a second overlay process;
3. Decoding picture partitioning parameters from syntax elements in the bitstream, the picture partitioning parameters specifying at least a first segment area and a second segment area, wherein
   the first segment area is the segment area that the first overlay process is applied to;
   the second segment area is the segment area that the second overlay process is applied to;
   the boundaries of at least one of the first segment area and the second segment area are not fully aligned with the boundaries of the picture or boundaries of subpictures or boundaries of slices in the picture; and
4. Decoding the picture where decoding the picture comprises
   applying the first overlay process on the first segment area of the picture using the first set of one or more overlay process parameters.
   applying the second overlay process on the second segment area of the picture using the second set of one or more overlay process parameters.

In one variant of this embodiment the first segment area is the same as the second segment area.

In another variant of this embodiment, a first set of one or more overlay process parameters P1 and a first set of one or more picture partitioning parameters specifying a first overlay process area A1 are decoded from a first NAL unit, and a second set of one or more overlay process parameters P2 and a second set of one or more picture partitioning parameters specifying a second overlay process area A2 are decoded from a second NAL unit. A first picture is then decoded using P1, A1, P2 and A2.

In another variant of this embodiment, a first set of one or more overlay process parameters P1 is decoded from a first NAL unit and a first set of one or more picture partitioning parameters specifying a first overlay process area A1 is decoded from a second NAL unit, and a second set of one or more overlay process parameters P2 is decoded from a third NAL unit and a second set of one or more picture partitioning parameters specifying a second overlay process area A2 is decoded from a fourth NAL unit. A first picture is then decoded using P1, A1, P2 and A2. In another variant of this embodiment a first and a third NAL unit are the same NAL unit and the second and the fourth NAL unit are the same NAL unit.

An encoder may perform all or a subset of the following steps according to this embodiment:
1. Specifying a first overlay process by specifying a first set of one or more overlay process parameters for the picture.
2. Specifying a second overlay process by specifying a second set of one or more overlay process parameters for the picture.
3. Specifying set of one or more picture partitioning parameters specifying at least a first segment area and a second segment area, where
   the first segment area is the segment area that the first overlay process is applied to,
   a second segment area is the segment area that the second overlay process is applied to
   the boundaries of at least one of the first segment area and the second segment area are not fully aligned with the boundaries of the picture or the boundaries of subpictures or boundaries of slices in the picture.
4. Encoding the set of one or more picture partitioning parameters into the bitstream
5. Encoding the first set of one or more overlay process parameters into the bitstream.
6. Encoding the second set of one or more overlay process parameters into the bitstream.

### Embodiment 6—Signalling of Overlay Process Parameters

In this embodiment, the set(s) of overlay parameters are signalled in a parameter set such as APS, SPS, PPS and the picture partitioning parameters, which specify one or more segment areas, are signalled together with information indicating, for each specified segment area, which overlay parameters are applied to that segment area. For example, multiple sets of overlay parameters such as multiple sets of renoising filter models with different model IDs may be signalled. In one embodiment, an ID is assigned to each set of one or more overlay process parameters signalled in a parameter set and the set of one or more picture partitioning parameters are signalled in an SEI message together with the corresponding ID of the set of one or more overlay process parameters to each of the segment area to specify which of the overlay processes is applied to the segment area.

A decoder may perform all or a subset of the following steps according to this embodiment:
1. Decoding a first set of one or more overlay process parameters from syntax elements in a header or parameter set in the bitstream, the first set of one or more overlay process parameters specifying a first overlay process.
2. Decoding a first overlay process parameter ID corresponding to the first set of one or more overlay process parameters.
3. Decoding a second set of one or more overlay process parameters from syntax elements in a header or parameter set in the bitstream, the second set of one or more overlay process parameters specifying a second overlay process.
4. Decoding a second overlay process parameter ID corresponding to the second set of one or more overlay process parameters.
5. Decoding picture partitioning parameters from syntax elements in the bitstream, the picture partitioning parameters specifying at least a first segment area, where the boundaries of the first segment area are not fully aligned with the boundaries of the picture or boundaries of subpictures or boundaries of slices in the picture.
6. Decoding an indication from the bitstream specifying which of the first or the second overlay process is to be applied to the first segment area.
7. Decoding the picture where decoding the picture comprises applying the first or the second overlay process to the first segment area of the picture in response to the indication specifying which of the first or the second overlay process to be applied to the first segment area.

An encoder may perform all or a subset of the following steps according to this embodiment:
1. Specifying a first overlay process by specifying a first set of one or more overlay process parameters for the picture.
2. Specifying a first overlay process parameter ID corresponding to the first set of one or more overlay process parameters.
3. Specifying a second overlay process by specifying a second set of one or more overlay process parameters for the picture.
4. Specifying a second overlay process parameter ID corresponding to the second set of one or more overlay process parameters.
5. Specifying picture partitioning parameters that specifies at least a first segment area, where the boundaries of the first segment area are not fully aligned with the boundaries of the picture or boundaries of subpictures or boundaries of slices in the picture.
6. Specifying an indication for which of the first or the second overlay process corresponds to the first segment area.
7. Encoding the picture partitioning parameters into the bitstream.
8. Encoding the first set of one or more overlay process parameters into the bitstream.
9. Encoding the second set of one or more overlay process parameters into the bitstream.
10. Encoding the indication for which of the first or the second overlay process corresponds to the first segment area into the bitstream.

### Embodiment 7

This embodiment is similar to Embodiment 1 but focuses on the shape of the segment area(s). In this embodiment the segment areas may have the shape of a rectangular area, a polygon area, a free form area, or other geometrically shaped segment areas that the picture can be partitioned into. A rectangular segment area may be specified by means of the position of top-left corner and its horizontal and vertical size or by the position of its two diagonal corners and the knowledge of its orientation or by other means.

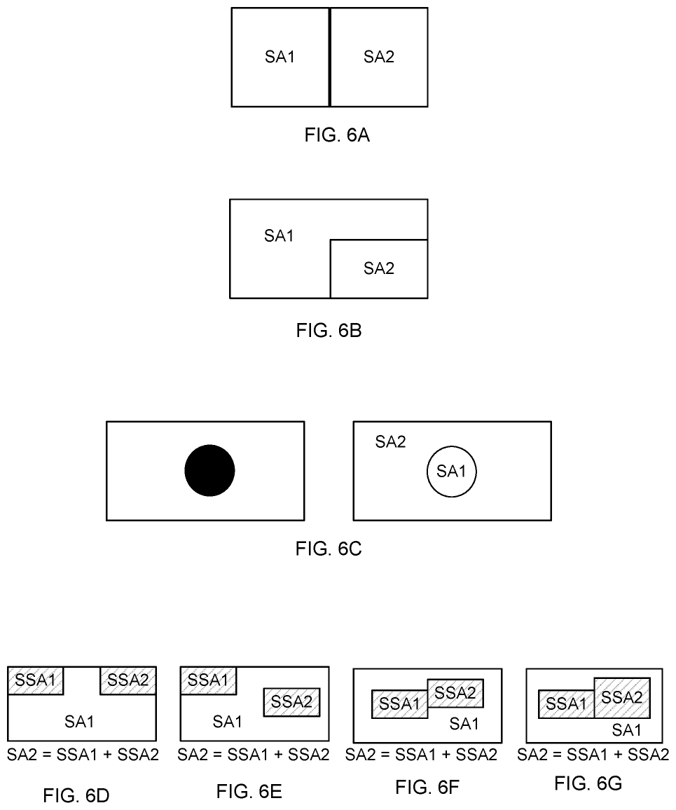

FIG. 6A illustrates a picture that is partitioned into two rectangular segment areas SA1 and SA2.

FIG. 6B illustrates a picture that is partitioned into two segment areas SA1 and SA2 where SA1 is not a rectangular segment area.

A segment area may be specified directly or indirectly by removing the specified areas from the picture and specifying the remaining areas of the picture as a segment area.

In a variant of this embodiment, the shape of a segment area is specified using a mask. A mask may partition a picture into two segment areas, one specified by the black part of the mask and one specified by the white part of the mask.

FIG. 6C illustrates a mask that partitions a picture into two segment areas SA1 and SA2 corresponding to the black part and white part of the mask respectively.

### Embodiment 8—Union of Sub-Segment Areas

This embodiment is similar to Embodiment 1 with the addition that at least one of the segment areas is the union of at least two sub-segment areas (e.g., a first sub-segment area and a second sub-segment area). An example is shown in FIG. 6D, where a segment area (denoted SA2) is the union of two non-overlapping sub-segment areas denoted SSA1 and SSA2. Non-overlapping Sub-segment areas may be connected (see, e.g., FIG. 6F and FIG. 6G) or unconnected to each other (see, e.g., FIGS. 6D and 6E). In this embodiment, the picture partitioning parameters that specify a segment area may include at least: i) a first set of picture partitioning parameters that define a first sub-segment area and ii) a second set of picture partitioning parameters that define a second sub-segment area. Additionally, the picture partitioning parameters that specify the segment area may include an indicator indicating that the segment area is defined as the union of the specified sub-segment areas.

### Embodiment 9—Partitioning Picture into Segment Areas Using a List

This embodiment is similar to Embodiment 1 with the addition that the segment areas may be specified using position and/or size information, or a list or array or pointers to a list of predefined masks or area forms. The segment areas may also be specified using straight lines that partition the picture into segment areas.

### Embodiment 10—Blending of Overlay Processes

In this embodiment, more than one overlay process is specified (e.g. P1 and P2) and the overlay process areas OPA1 for P1 and OPA2 for P2 overlap partially or completely and the overlap area is specified as segment area OPA1∩OPA2 and one of the followings may be applied to the segment area OPA1∩OPA2 according to a rule such as:
P1 and P2 applied sequentially;
A blending of the two overlay processes as P1*P2;
One of P1 or P2;
A weighted combination of P1 and P2.

### Embodiment 11—Segment areas based on color values

This embodiment is similar to Embodiment 1 with the addition that the overlay process areas may be specified using the color values in the picture. Examples of areas with specific color values and distributions are like sky, grass, human skin, etc. In one example of this embodiment the overlay process area is specified as the areas in the picture that have a certain color value distributions and an overlay process such as a renoising process is applied to that particular overlay process areas of the picture.

### Embodiment 12—A Flag to Specify Applying the Overlay Process to an Explicitly Defined Segment Area or all Picture Except the Explicitly Defined Segment Area

This embodiment is similar to Embodiment 1 with the addition that a syntax element, denoted f1, equal to a first value specifies if an overlay process is applied to a specified segment area or an overlay process is applied to the entire picture except the specified segment area. One example of this embodiment is applying film grain process to the picture everywhere but not the segment area corresponding to a human face or the area with a particular color value or within a range of color values.

### Embodiment 13—Per Temporal Sublayer Solution for the Overlay Processes

In this embodiment, it is specified that the overlay process is applied to one or a subset of the temporal sublayers in a layer. In one example of this embodiment, the temporal ID value(s) of the temporal sublayer(s) that the overlay process applies to is specified in the same NAL unit that the overlay process is specified. In another example of this embodiment, the temporal ID value(s) of the temporal sublayer(s) that the overlay process applies to is specified in a second NAL unit which is different from a first NAL unit where the overlay process is specified.

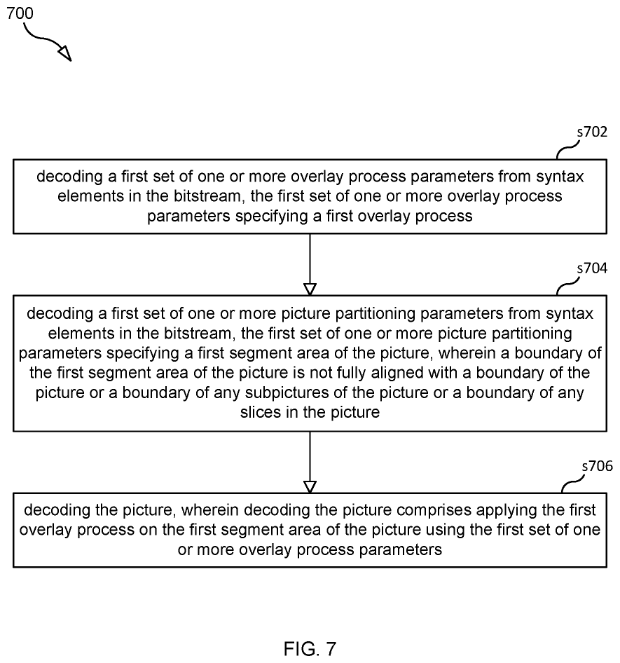

FIG. 7 is a flow chart illustrating a process 700, according to an embodiment, for applying an overlay process to a picture in a bitstream. Process 700 is performed by UE 500. Process 700 may begin in step s702. Step s702 comprises decoding a first set of one or more overlay process parameters from syntax elements in the bitstream, the first set of one or more overlay process parameters specifying a first overlay process. Step s704 comprises decoding a first set of one or more picture partitioning parameters from syntax elements in the bitstream, the first set of one or more picture partitioning parameters specifying a first segment area of the picture, wherein a boundary of the first segment area of the picture is not fully aligned with a boundary of the picture or a boundary of any subpictures of the picture or a boundary of any slices in the picture. Step s706 comprises decoding the picture, wherein decoding the picture comprises applying the first overlay process on the first segment area of the picture using the first set of one or more overlay process parameters.

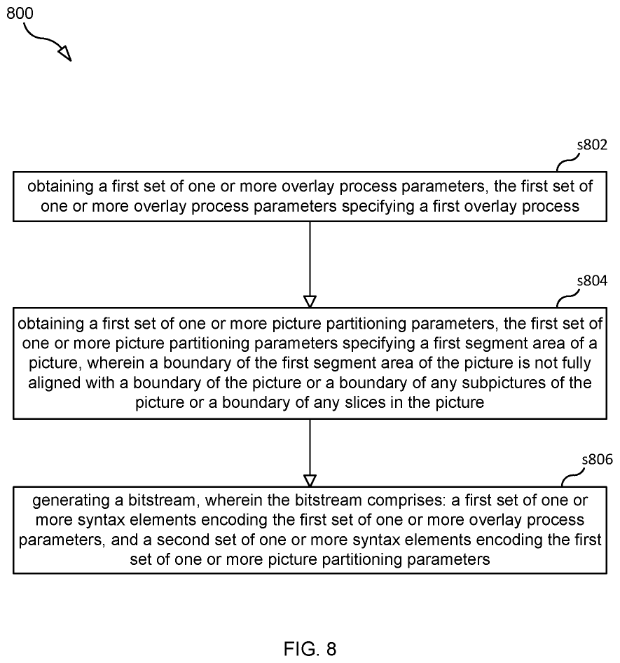

FIG. 8 is a flow chart illustrating a process 800, according to an embodiment. Process 800 is performed by encoder 202. Process 800 may begin in step s802. Step s802 comprises obtaining a first set of one or more overlay process parameters, the first set of one or more overlay process parameters specifying a first overlay process. Step s804 comprises obtaining a first set of one or more picture partitioning parameters, the first set of one or more picture partitioning parameters specifying a first segment area of a picture, wherein a boundary of the first segment area of the picture is not fully aligned with a boundary of the picture or a boundary of any subpictures of the picture or a boundary of any slices in the picture. Step s806 comprises generating a bitstream, wherein the bitstream comprises a first set of one or more syntax elements encoding the first set of one or more overlay process parameters, and a second set of one or more syntax elements encoding the first set of one or more picture partitioning parameters.

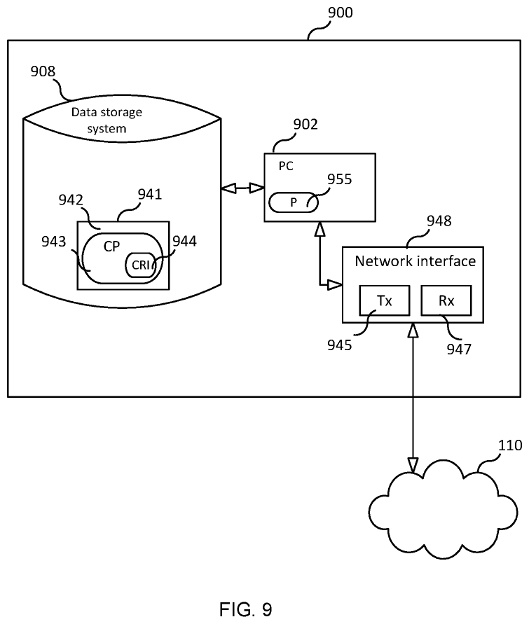

FIG. 9 is a block diagram of an apparatus 900 for implementing UE 500 and/or encoder 202, according to some embodiments. When apparatus 900 implements a UE, apparatus 900 may be referred to as a “UE apparatus 900,” and when apparatus 900 implements an encoder, apparatus 900 may be referred to as an “encoding apparatus 900.” As shown in FIG. 9, apparatus 900 may comprise: processing circuitry (PC) 902, which may include one or more processors (P) 955 (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed (i.e., apparatus 900 may be a distributed computing apparatus); at least one network interface 948 comprising a transmitter (Tx) 945 and a receiver (Rx) 947 for enabling apparatus 900 to transmit data to and receive data from other nodes connected to a network 110 (e.g., an Internet Protocol (IP) network) to which network interface 948 is connected (directly or indirectly) (e.g., network interface 948 may be wirelessly connected to the network 110, in which case network interface 948 is connected to an antenna arrangement); and a storage unit (a.k.a., “data storage system”) 908, which may include one or more non-volatile storage devices and/or one or more volatile storage devices. In embodiments where PC 902 includes a programmable processor, a computer program product (CPP) 941 may be provided. CPP 941 includes a computer readable medium (CRM) 942 storing a computer program (CP) 943 comprising computer readable instructions (CRI) 944. CRM 942 may be a non-transitory computer readable medium, such as, magnetic media (e.g., a hard disk), optical media, memory devices (e.g., random access memory, flash memory), and the like. In some embodiments, the CRI 944 of computer program 943 is configured such that when executed by PC 902, the CRI causes apparatus 900 to perform steps described herein (e.g., steps described herein with reference to the flow charts). In other embodiments, apparatus 900 may be configured to perform steps described herein without the need for code. That is, for example, PC 902 may consist merely of one or more ASICs. Hence, the features of the embodiments described herein may be implemented in hardware and/or software.

### Summary of Various Embodiments

A1. A method (700) for applying an overlay process to a picture in a bitstream, the method comprising decoding a first set of one or more overlay process parameters from syntax elements in the bitstream, the first set of one or more overlay process parameters specifying a first overlay process; decoding a first set of one or more picture partitioning parameters from syntax elements in the bitstream, the first set of one or more picture partitioning parameters specifying a first segment area of the picture, wherein a boundary of the first segment area of the picture is not fully aligned with a boundary of the picture or a boundary of any subpictures of the picture or a boundary of any slices in the picture; and decoding the picture, wherein decoding the picture comprises applying the first overlay process on the first segment area of the picture using the first set of one or more overlay process parameters.

A2. The method of embodiment A1, further comprising: decoding a first indicator value from a first syntax element in the bitstream, wherein applying the first overlay process on the first segment area of the picture using the first set of one or more overlay process parameters is done in response to the first indicator value being equal to a first value.

A3. The method of embodiment A2, further comprising: decoding a second set of one or more overlay process parameters from syntax elements in the bitstream, the second set of one or more overlay process parameters specifying a second overlay process; decoding a second set of one or more picture partitioning parameters from syntax elements in the bitstream, the second set of one or more picture partitioning parameters specifying a second segment area of the picture; decoding a second indicator value from a second syntax element in the bitstream; and either: in response to the second indicator value being equal to a first value, applying the second overlay process on the second segment area of the picture using the second set of one or more overlay process parameters, or in response to the second indicator value being equal to a second value, not applying the second overlay process on the second segment area of the picture.

A4. The method of embodiment A2, further comprising: decoding a second indicator value from a second syntax element in the bitstream; decoding from the bitstream additional picture portioning parameters specifying a second segment area of the picture; and in response to the second indicator value being equal to a second value, not applying the first overlay process to the second segment area.

A5. The method of any one of the previous embodiments, wherein the first set of one or more picture partitioning parameters implicitly specifies the first segment area of the picture by explicitly specifying a complementary segment area of the picture, wherein the first segment area of the picture is specified as the area of the picture that is not part of the explicitly specified complementary segment area.

A6. The method of any one of the previous embodiments, wherein the first set of one or more picture partitioning parameters further implicitly specifies a second segment area, wherein the second segment area is the area of the picture that is not part of the first segment area.

A7. The method of any one of the previous embodiments, wherein the first set of one or more picture partitioning parameters and the first set of one or more overlay process parameters are signalled in the same Network Abstraction Layer (NAL) unit.

A8. The method of any one of the previous embodiments, wherein the first set of one or more overlay process parameters are decoded from syntax elements in the bitstream in response to the first indicator value being equal to a certain value; or the first set of one or more overlay process parameters are decoded from syntax elements in the bitstream in response to a third indicator value decoded from the bitstream being equal to a certain value.

A9. The method of any one of the previous embodiments, wherein the first set of one or more picture partitioning parameters specifies the first segment area of the picture by specifying at least one of: a color value, a luminance value, or a local similarity index value.

A10. The method of embodiment A2 or any embodiment that depends from embodiment A2, wherein the first syntax element is a flag.

A11. The method of any one of the previous embodiments, wherein the first segment area of the picture comprises at least one of: i) a part of a slice but not all of the slice, ii) a part of a tile but not all of the tile, iii) a part of a CTU but not all of the CTU, or iv) a part of a CU but not all of the CU.

A12. The method of any one of the previous embodiments, wherein the first segment area of the picture is a non-rectangular area.

A13. The method of any one of the previous embodiments, wherein the first segment area of the picture comprises at least a first sub-segment area and a second sub-segment area.

A13a. The method of embodiment A13, wherein the first and second sub-segment areas do not overlap.

A13b. The method of embodiment A13, wherein the first and second sub-segment areas are unconnected.

A14. The method of any one of the previous embodiments, wherein the overlay process is a film grain process.

A15. The method of any one of the previous embodiments, wherein the overlay process is a renoising process, a denoising process, or a post filtering process.

A16. The method of any one of the previous embodiments, wherein the first set of one or more overlay process parameters comprises at least one of: an overlay process model type parameter, an overlay process strength parameter, or an overlay process seed parameter.

A17. The method of any one of the previous embodiments, wherein the first set of one or more overlay process parameters is signalled in an SEI message, a parameter set (e.g., APS, PPS, SPS or VPS), a picture header, or a slice header.

A18. The method of any one of the previous embodiments, wherein an overlay process is applied to one or a subset of layers or to one or a subset of temporal sublayers in one layer.

A19. The method of embodiment A18, wherein applying an overlay process to one or a subset of temporal sublayers in one layer comprises applying an overlay process to one or a subset of temporal sublayers in one layer using a subset of the temporal sublayer IDs belonging to the one or a subset of temporal sublayers.

A20. The method of embodiment A2 or any embodiment that depends from embodiment A2, wherein the first indicator value is decoded from: a slice header, a picture header, a parameter set (e.g., an APS, PPS, SPS or VPS), or an SEI message.

A21. The method of any one of the previous embodiments, wherein at least one of the boundaries of the first segment area of the picture is not a slice boundary.

B1. A method (800) performed by an encoder, the method comprising obtaining a first set of one or more overlay process parameters, the first set of one or more overlay process parameters specifying a first overlay process; obtaining a first set of one or more picture partitioning parameters, the first set of one or more picture partitioning parameters specifying a first segment area of a picture, wherein a boundary of the first segment area of the picture is not fully aligned with a boundary of the picture or a boundary of any subpictures of the picture or a boundary of any slices in the picture; and generating a bitstream, wherein the bitstream comprises: a first set of one or more syntax elements encoding the first set of one or more overlay process parameters, and a second set of one or more syntax elements encoding the first set of one or more picture partitioning parameters.

B2. The method of embodiment B1, wherein the bitstream further comprises a first indicator syntax element encoding a first indicator, wherein the value of the first indicator indicates whether or not the first overlay process should be applied to the first segment area.

B3. The method of embodiment B2, further comprising: obtaining a second set of one or more overlay process parameters, the second set of one or more overlay process parameters specifying a second overlay process; and obtaining a second set of one or more picture partitioning parameters, the second set of one or more picture partitioning parameters specifying a second segment area of a picture, wherein the bitstream further comprises: a third set of one or more syntax elements encoding the second set of one or more overlay process parameters, a fourth set of one or more syntax elements encoding the second set of one or more picture partitioning parameters, and a second indicator syntax element encoding a second indicator, wherein the value of the second indicator indicates whether or not the second overlay process should be applied to the second segment area.

B3b. The method of embodiment B2, further comprising: encoding a second indicator value in the bitstream, wherein when the second indicator value is equal to a second value, the second indicator value indicates to a decoder that the decoder should decode from the bitstream picture portioning parameters specifying a second segment area of the picture and should not apply the first overlay process to the second segment area.

B4. The method of any one of embodiments B1-B3b, wherein the first set of one or more picture partitioning parameters implicitly specifies the first segment area of the picture by explicitly specifying a complementary segment area of the picture, wherein the first segment area of the picture is specified as the area of the picture that is not part of the explicitly specified complementary segment area.

B5. The method of any one of embodiments B1-B4, wherein at least one of the boundaries of the first segment area of the picture is not a slice boundary.

B6. The method of any one of embodiments B1-B5, wherein the first set of one or more picture partitioning parameters further implicitly specifies a second segment area, wherein the second segment area is the area of the picture that is not part of the first segment area.

B7. The method of any one of embodiments B1-B6, wherein the first set of one or more picture partitioning parameters and the first set of one or more overlay process parameters are signalled in the same Network Abstraction Layer (NAL) unit.

B8. The method of any one of embodiments B1-B7, wherein the first set of one or more picture partitioning parameters specifies the first segment area of the picture by specifying at least one of a color value, a luminance value, or a local similarity index value.

B9. The method of embodiment B2 or any embodiment that depends from embodiment B2, wherein the first indicator syntax element is a flag.

B10. The method of any one of embodiments B1-B9, wherein the first segment area of the picture comprises at least one of: i) a part of a slice but not all of the slice, ii) a part of a tile but not all of the tile, iii) a part of a CTU but not all of the CTU, or iv) a part of a CU but not all of the CU.

B11. The method of any one of embodiments B1-B10, wherein the first segment area of the picture is a non-rectangular area.

B12. The method of any one of embodiments B1-B11, wherein the first segment area of the picture comprises at least a first sub-segment area and a second sub-segment area.

B13. The method of embodiment B12, wherein the first and second sub-segment areas do not overlap.

B13b. The method of embodiment B12, wherein the first and second sub-segment areas are unconnected.

B14. The method of any one of embodiments B1-B13b, wherein the overlay process is a film grain process.

B15. The method of any one of embodiments B1-B14, wherein the overlay process is a renoising process, a denoising process, or a post filtering process.

B16. The method of any one of embodiments B1-B15, wherein the first set of one or more overlay process parameters comprises at least one of: an overlay process model type parameter, an overlay process strength parameter, or an overlay process seed parameter.

B17. The method of any one of embodiments B1-B16, wherein the first set of one or more overlay process parameters is signalled in an SEI message, a parameter set (e.g., APS, PPS, SPS or VPS), a picture header, or a slice header.

B18. The method of embodiment B2 or any embodiment that depends from embodiment B2, wherein the first indicator syntax element is comprised in: a slice header, a picture header, a parameter set (e.g., an APS, PPS, SPS or VPS), or an SEI message.

C1. A computer program (943) comprising instructions (944) which when executed by processing circuitry (902) causes the processing circuitry (902) to perform the method of any one of the above embodiments.

C2. A carrier containing the computer program of embodiment C1, wherein the carrier is one of an electronic signal, an optical signal, a radio signal, and a computer readable storage medium (942).

D1. An apparatus (900), the apparatus being adapted to perform the method of any one of embodiments A1-A21 or B1-B18.

E1. An apparatus (900), the apparatus comprising: memory (942); and processing circuitry (902), wherein the apparatus is configured to perform the method of any one of embodiments A1-A21 or B1-B18.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1-40. (canceled)

41. A method for applying an overlay process to a picture in a bitstream, the method comprising:
decoding a first set of one or more overlay process parameters from syntax elements in a first NAL unit in the bitstream, the first set of one or more overlay process parameters specifying a first overlay process;
decoding a first set of one or more picture partitioning parameters from syntax elements in a second NAL unit in the bitstream, wherein the first NAL unit is different from the second NAL unit, the first set of one or more picture partitioning parameters specifying a first segment area of the picture, wherein a boundary of the first segment area of the picture is not fully aligned with a boundary of the picture, is not fully aligned with a boundary of any subpictures of the picture, and is not fully aligned with a boundary of any slices in the picture; and
decoding the picture, wherein decoding the picture comprises applying the first overlay process on the first segment area of the picture using the first set of one or more overlay process parameters.

42. The method of claim 41, further comprising:
decoding a first indicator value from a first syntax element in the bitstream, wherein
applying the first overlay process on the first segment area of the picture using the first set of one or more overlay process parameters is done in response to the first indicator value being equal to a first value.

43. The method of claim 42, wherein the first syntax element is a flag.

44. The method of claim 42, wherein the first indicator value is decoded from: a slice header, a picture header, a parameter set, or an SEI message.

45. The method of claim 41, wherein the first set of one or more picture partitioning parameters specifies the first segment area of the picture by specifying at least one of: a color value, a luminance value, or a local similarity index value.

46. The method of claim 41, wherein the first segment area of the picture comprises at least one of: i) a part of a slice but not all of the slice, ii) a part of a tile but not all of the tile, iii) a part of a CTU but not all of the CTU, or iv) a part of a CU but not all of the CU.

47. The method of claim 41, wherein the overlay process is:
a film grain process,
a renoising process,
a denoising process, or
a post filtering process.

48. The method of claim 41, wherein at least one of the boundaries of the first segment area of the picture is not a slice boundary.

49. The method of claim 41, wherein the first set of one or more overlay process parameters comprises at least one of: an overlay process model type parameter, an overlay process strength parameter, or an overlay process seed parameter.

50. The method of claim 41, wherein the first set of one or more overlay process parameters is signalled in an SEI message, a parameter set, a picture header, or a slice header.

51. The method of claim 41, wherein an overlay process is applied to one or a subset of layers or to one or a subset of temporal sublayers in one layer.

52. The method of claim 51, wherein applying an overlay process to one or a subset of temporal sublayers in one layer comprises applying an overlay process to one or a subset of temporal sublayers in one layer using a subset of the temporal sublayer IDs belonging to the one or a subset of temporal sublayers.

53. A method performed by an encoder, the method comprising:
obtaining a first set of one or more overlay process parameters, the first set of one or more overlay process parameters specifying a first overlay process;
obtaining a first set of one or more picture partitioning parameters, the first set of one or more picture partitioning parameters specifying a first segment area of a picture, wherein a boundary of the first segment area of the picture is not fully aligned with a boundary of the picture, is not fully aligned with a boundary of any subpictures of the picture, and is not fully aligned with a boundary of any slices in the picture; and
generating a bitstream, wherein the bitstream comprises:
a first NAL unit comprising a first set of one or more syntax elements encoding the first set of one or more overlay process parameters, and
a second NAL unit comprising a second set of one or more syntax elements encoding the first set of one or more picture partitioning parameters, wherein the first NAL unit is different from the second NAL unit.

54. The method of claim 53, wherein the bitstream further comprises a first indicator syntax element encoding a first indicator, wherein the value of the first indicator indicates whether or not the first overlay process should be applied to the first segment area.

55. The method of claim 54, wherein the first indicator syntax element is comprised in: a slice header, a picture header, a parameter set, or an SEI message.

56. The method of claim 53, wherein the first set of one or more picture partitioning parameters specifies the first segment area of the picture by specifying at least one of: a color value, a luminance value, or a local similarity index value.

57. The method of claim 53, wherein the first segment area of the picture comprises at least one of: i) a part of a slice but not all of the slice, ii) a part of a tile but not all of the tile, iii) a part of a CTU but not all of the CTU, or iv) a part of a CU but not all of the CU.

58. The method of claim 53, wherein the overlay process is
a film grain process,
a renoising process,
a denoising process, or
a post filtering process.

59. The method of claim 53, wherein
the first set of one or more overlay process parameters comprises at least one of: an overlay process model type parameter, an overlay process strength parameter, or an overlay process seed parameter, and
the first set of one or more overlay process parameters is signalled in an SEI message, a parameter set, a picture header, or a slice header.

60. A non-transitory computer readable storage medium storing a computer program comprising instructions which when executed by processing circuitry of an apparatus causes the apparatus to perform the method of claim 41.
